(19) United States
(12) Patent Application Publication
(10) Pub. No.: US 2018/0122184 A1
(43) Pub. Date: May 3, 2018

(54) Software-Based Simulation of Symbol Locking

(71) Applicant: Pridefield Limited, Douglas (GB)

(72) Inventor: Jonathan Bruce Wortmann, Ballarat (AU)

(21) Appl. No.: 15/796,122

(22) Filed: Oct. 27, 2017

(30) Foreign Application Priority Data
Oct. 31, 2016 (GB) 1618352.7

(51) Int. Cl. G07F 17/32; G07F 17/34

(52) U.S. Cl. CPC G07F 17/3213; G07F 17/3244; G07F 17/326; G07F 17/34; G07F 17/3225

(57) ABSTRACT

An embodiment may involve a software application executed on behalf of a client machine with a graphical display unit, where the software application involves graphically displaying, on vertical symbol display segments of the graphical display unit, animations that simulate spinning a plurality of reels. The embodiment may also involve: selecting a first set of symbols associated with respective positions of each of the reels; determining that the first set of symbols includes exactly one or exactly two trigger symbols; locking in place all instances of the trigger symbols; selecting a second set of symbols associated with the respective positions of each of the reels, where the second set of symbols includes the locked-in-place trigger symbols; determining that the second set of symbols includes at least three trigger symbols; and providing an additional spin of the reels to the client machine, and unlocking all locked-in-place in place trigger symbols.

### CROSS-REFERENCE TO RELATED APPLICATION

This application claims priority to U.K. patent application no. 1618352.7, filed Oct. 31, 2016, which is hereby incorporated by reference in its entirety.

### BACKGROUND

Wager games come in a variety of forms, including for example a mechanical slot machine. A mechanical slot machine may include one or more reels, each of which includes a fixed pattern of symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predefined winning symbol or a predefined combination of winning symbols that are aligned with the pay line can result in the player winning the game and receiving a payout. In one example, the machine may include three reels, and the pay line may be a horizontal line disposed across a centre of each of the three reels.

In another example of a wager game, a mechanical slot machine may present symbols in a matrix arrangement, with each symbol changing during a spin of the game according to the fixed pattern of symbols on the reels. For example, the machine may have five columns and three rows of symbols, for a total of fifteen symbols. Such machines often have multiple pay lines, each being defined by a collection of positions within the matrix. For instance, the machine may have three pay lines, each corresponding to one row of the matrix.

### SUMMARY

While slot machines were traditionally mechanical, modern slot machines often take the form of a video gaming machine (e.g., a dedicated gaming machine located in a casino) that includes a graphical user interface (GUI), and that may emulate a mechanical slot machine. With a video gaming machine, the GUI may display an image of one or more reels or a matrix as described above, together with animation effects to simulate a spin of the one or more reels, or a spin of the columns or rows of the matrix. A computer software program, which may reside in the video gaming machine, may randomly select one or more symbols in response to a spin, and may display the selected one or more symbols on the display.

A modern slot machine may also be played over a computer network, such as by a player using a client machine that is connected to a server machine by the computer network. In this instance, the server machine may perform the spins of the game and may send data representing the resulting symbols to the client machine, thereby instructing the client machine to display the symbols.

The popularity of video slot games has increased due to the incorporation of novel features, such as a “Wild” symbol and a “Scatter” symbol, into such games. These features may assist in making winning results and provide a player with entertainment and additional opportunities to win games.

A Wild symbol, which is usually the highest-ranking symbol of the game, offers line payouts, just like any other symbol and, additionally, substitutes for any other symbol in the game except for Scatter symbols, thereby assisting in making winning results and providing a player with entertainment and additional opportunities to win games.

Unlike predefined winning symbols or predefined combinations of symbols that must be aligned with a pay line in order for the player to win the game and receive a payout, Scatter symbols need not appear on a pay line in order for the player to receive a payout or for additional game features to be unlocked.

In a bonus game of a 5-reel video slot game, three or more Scatter symbols may trigger an award of free spins. If at least one but less than three Scatter symbols appears during play of the bonus game, any Scatter symbol that appears may be locked-down until sufficient Scatter symbols accumulate to trigger the award of free spins.

Further, in some cases, if Scatter symbols appear during play of the bonus game, the Scatter symbols may be replaced by Wild symbols, and these Wild symbols may enhance any payout associated with the displayed symbols.

Viewed from a first aspect, the disclosure involves a computer-implemented method for symbol selection in a reel-based game. The reel-based game is executed on behalf of a client machine, and the reel-based game involves spinning a plurality of reels to determine outcome events. A memory may store respective pluralities of symbols for the reels. Accordingly, a first set of symbols associated with respective positions of each of the reels may be selected as a bonus outcome event of the reel-based game. The bonus outcome event may have been caused by a trigger event in a base game of the reel-based game. The first set of symbols may be stored in the memory. It may be determined that the first set of symbols includes at least one but less than n trigger symbols. In response to determining that the first set of symbols includes at least one but less than n trigger symbols, all instances of the trigger symbols in the first set of symbols may be locked in place. The locked trigger symbols may persist for at least one further bonus outcome event. The first set of symbols stored in the memory may be updated to indicate that the trigger symbols are locked in place. A representation of the first set of symbols may be transmitted to the client machine. Reception of the representation of the first set of symbols may cause the client machine to display the first set of symbols on a screen. A second set of symbols associated with the respective positions of each of the reels may be selected as a further bonus outcome event of the reel-based game. The second set of symbols may include the locked in place trigger symbols from the first set of symbols.

Viewed from a second aspect, the disclosure provides an article of manufacture including a non-transitory computer-readable medium, having stored thereon program instructions that, upon execution by a gaming machine, cause the gaming machine to perform the operations of the first aspect.

Viewed from a third aspect, the disclosure provides a gaming machine configured to perform the operations of the first aspect.

Viewed from a fourth aspect, the disclosure provides a system comprising means for performing the operations of the first aspect.

Viewed from a fifth aspect, the disclosure provides a gaming system that comprises a plurality of client machines each including at least one display device and a plurality of input devices including: (i) an acceptor of a physical item associated with a monetary value, (ii) a validator configured to identify the physical item, and (iii) a cash-out button actuatable to cause an initiation of a payout associated with a credit account; one or more client machine processors; and one or more client machine memory devices storing (i) respective pluralities of symbols for the reels and (ii) a plurality of client machine instructions. The client machine instructions may be executable by the one or more client machine processors to perform the operations of the first aspect.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a simplified block diagram of a machine, in accordance with example embodiments.

FIG. 2 is a simplified block diagram of an example server machine connected to an example client machine over a computer network, in accordance with example embodiments.

FIG. 3 depicts diagrams of tables that may be used with the processes, machines, and systems herein, in accordance with example embodiments.

FIG. 4 depicts elements displayable by a display of a machine, in accordance with example embodiments.

FIG. 5 depicts an example of a selected symbol set in a display, in accordance with example embodiments.

FIG. 6A is a first part of a flow chart, in accordance with example embodiments.

FIG. 6B is a second part of the flow chart of FIG. 6A, in accordance with example embodiments.

FIG. 6C is a third part of the flow chart of FIG. 6A, in accordance with example embodiments.

FIG. 6D is a fourth part of the flow chart of FIG. 6A, in accordance with example embodiments.

FIG. 7 depicts an example of a selected symbol set in a display, in accordance with example embodiments.

FIG. 8 depicts an example of the symbol set of FIG. 7 that includes a number of replacement symbols, in accordance with example embodiments.

FIG. 9 depicts an example of a selected symbol set in a display, in accordance with example embodiments.

FIG. 10 depicts an example of the symbol set of FIG. 7 that includes a number of replacement symbols, in accordance with example embodiments.

FIG. 11A is a first part of a flow chart, in accordance with example embodiments.

FIG. 11B is a second part of the flow chart of FIG. 11A, in accordance with example embodiments.

FIG. 11C is a third part of the flow chart of FIG. 11A, in accordance with example embodiments.

FIG. 11D is a fourth part of the flow chart of FIG. 11A, in accordance with example embodiments.

FIG. 12A is a first part of a flow chart, in accordance with example embodiments.

FIG. 12B is a second part of the flow chart of FIG. 12A, in accordance with example embodiments.

FIG. 12C is a third part of the flow chart of FIG. 12A, in accordance with example embodiments.

FIG. 12D is a fourth part of the flow chart of FIG. 12A, in accordance with example embodiments.

FIG. 13 is a flow chart, in accordance with example embodiments.

FIG. 14 depicts elements displayable by a display of a machine, in accordance with example embodiments.

FIG. 15 depicts elements displayable by a display of a machine, in accordance with example embodiments.

FIG. 16 depicts elements displayable by a display of a machine, in accordance with example embodiments.

FIG. 17 depicts elements displayable by a display of a machine, in accordance with example embodiments.

FIG. 18 depicts elements displayable by a display of a machine, in accordance with example embodiments.

FIG. 19 depicts elements displayable by a display of a machine, in accordance with example embodiments.

### DETAILED DESCRIPTION

### I. Introduction

This description describes several example embodiments including, but not limited to, example embodiments pertaining to performing aspects of an outcome event using a machine. Performing the outcome event can include playing a game. The machine can display a variety of symbols during performance of an outcome event. A symbol displayed within a symbol-display-portion of a display during an outcome event may be replaced by another symbol. The replacement symbols can be used to determine a payout amount for an outcome event in which a wager is won.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Disclosed herein are machines, systems, and methods for carrying out aspects of outcome events that include displaying symbols. These aspects may be incorporated into games, in particular, wager games. In one aspect, the machines, systems, and methods provide a feature that may enhance traditional wager games (e.g., slot machines or other reel-type games) by providing a player with additional opportunities to win the game, thereby increasing the player's interest, anticipation, and excitement in connection with the game. This may in turn benefit a casino or another entity that provides a game with this feature. Indeed, wager games are typically configured to have odds that favour the casino (sometimes referred to as the “house”). Accordingly, based on the law of averages, casinos often increase their profits simply by getting more players to play more games. Due to the provided features, players may be drawn in (e.g., from competing casinos that lack games with such a feature) and they may play the game often. The feature can include new data communications between a server machine and a client machine within a server-client based configuration.

### II. Example Architecture

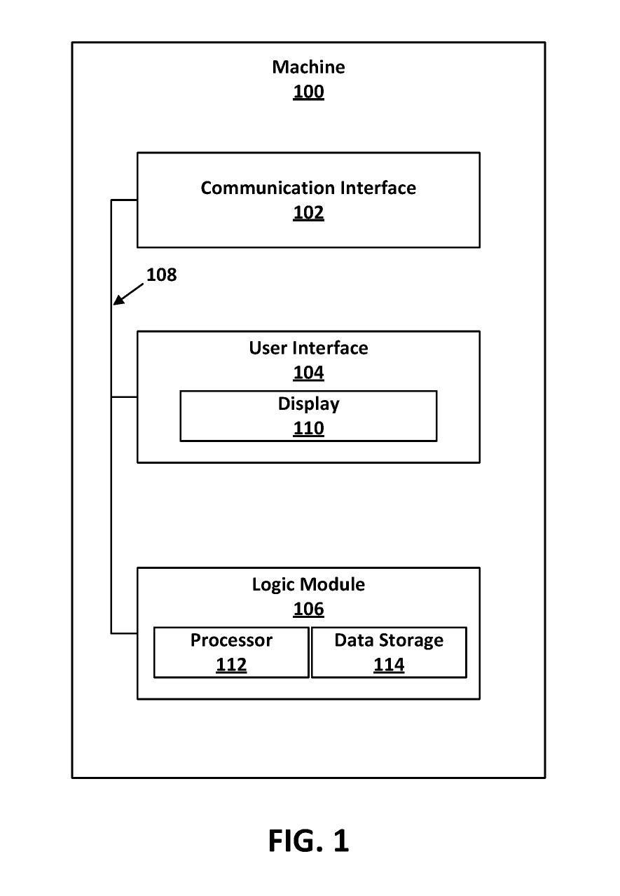

FIG. 1 shows a simplified block diagram of an example machine 100 arranged to implement operations in accordance with example methods described herein. Machine 100 may take any of a variety of forms, including for example a dedicated gaming machine, a personal computer, a server computer, a personal digital assistant, a mobile phone, a tablet device, or some other computing device.

Machine 100 may include a communication interface 102, a user interface 104, and a logic module 106, all of which may be coupled together by a system bus, network, or other connection mechanism 108. The communication interface 102 may include a wired or wireless network communication interface. For purposes of this description, any data described as being provided, sent, or transmitted by machine 100 can be data sent by communication interface 102 over a communication network. Also, for purposes of this description, any data described as being received by machine 100 can be data sent to communication interface 102 over a communication network.

The user interface 104 may facilitate interaction with a user (e.g., a player of a game) if applicable. As such, the user interface 104 may take the form of a GUI and may include output components such as a speaker and a display 110, and input components such as a keypad, keyboard, mouse, or a touch-sensitive screen. As described in greater detail below, display 110 may be configured to show, among other things, a symbol set in a game or a portion thereof.

The logic module 106 can take the form of a processor 112 and a data storage 114. The processor 112 can include a general-purpose processor (e.g., a microprocessor) or a special-purpose processor (e.g., a digital signal processor or an application specific integrated circuit) and may be integrated in whole or in part with the communication interface 102 or the user interface 104. Any processor discussed in this description or shown in the drawings can be referred to as a computer-readable processor. Any data storage discussed in this description or shown in the drawings can be referred to as computer-readable data storage.

Data storage 114 may include volatile or non-volatile storage components and may be integrated in whole or in part with processor 112. Data storage 114 may take the form of a non-transitory computer-readable medium and may include software program instructions, that when executed by processor 112, cause machine 100 to perform one or more of the operations described herein. Any software program instructions discussed in this description or shown in the drawings can be referred to as computer-readable program instructions, or more simply, program instructions.

Data storage 114 may also include operating system software on which machine 100 may operate. For example, machine 100 may operate on a Windows®-based operating system (e.g., Windows 7 or Windows 10) provided by the Microsoft® Corporation of Redmond, Wash. Other examples of operating systems are possible.

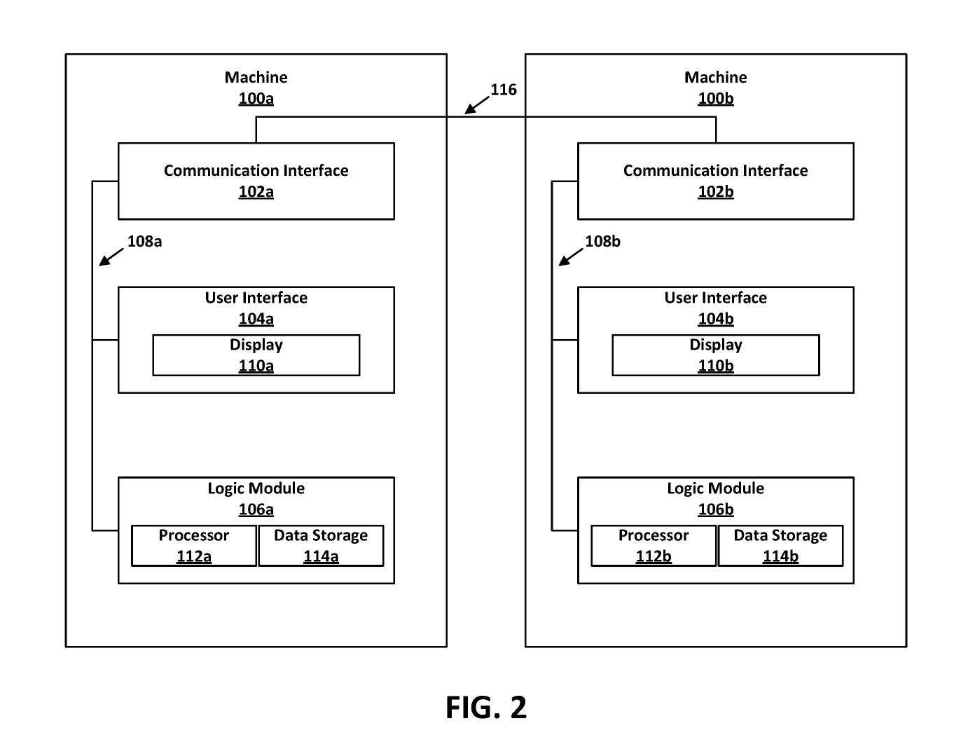

FIG. 2 is a simplified block diagram of an example server machine 100a connected to an example client machine (sometimes referred to as a workstation) 100b over a communication network 116. A configuration of elements including server machine 100a and client machine 100b can be referred to as a server-client based configuration.

The components of the server machine 100a and the client machine 100b are shown with corresponding “a” and “b” reference numerals (i.e., based on machine 100). Server machine 100a includes communication interface 102a, user interface 104a (which incorporates display screen 110a), logic module 106a (which incorporates processor 112a and data storage 114a), and communication bus 108a. Likewise, client machine 100b includes communication interface 102b, user interface 104b (which incorporates display screen 110b), logic module 106b (which incorporates processor 112b and data storage 114b), and communication bus 108b.

The server machine 100a is configured to communicate with the client machine 100b over communication network 116 (via the communication interfaces 102a, 102b). Likewise, the client machine 100b is configured to communicate with the server machine 100a over the communication network 116. For purposes of this description, any data described as being sent or transmitted by the server machine 100a can be data sent by communication interface 102a over communication network 116. Similarly, any data described as being sent or transmitted by the client machine 100b can be data sent by communication interface 102b over communication network 116. Furthermore, for purposes of this description, any data described as being received by the server machine 100a can be data the server machine 100a receives from the communication network 116 using communication interface 102a. Similarly, any data described as being received by the client machine 100b can be data the client machine 100b receives from the communication network 116 using communication interface 102b.

The communication network 116 for the server-client based configuration described above may take a variety of forms. For example, the communication network 116 may be a local area network (LAN) in a casino, such that client machines 100b dispersed throughout the casino may communicate with the server machine 100a in the casino.

In another example, the communication network 116 may be a wide-area network (WAN), such as an Internet network or a network of the World Wide Web. In such a configuration, the client machine 100b may communicate with the server machine 100a via a website portal (for a virtual casino) hosted on the server machine 100a. The data described herein as being transmitted by server machine 100a to client machine 100b or by client machine 100b to server machine 100a can be transmitted as datagrams according to the user datagram protocol (UDP), the transmission control protocol (TCP), or another protocol.

The communication network 116 may include any of a variety of network topologies and network devices, and may employ traditional network-related technologies, including for example the public switched telephone network, cable networks, cellular wireless networks, WiFi, and WiMAX. Further, the communication network 116 may include one or more databases (e.g., a player credit account database), to allow for the storing and retrieving of data related to performing an outcome event by a machine, as well as adjusting account balances associated with client machines.

In some examples, machine 100 may include an acceptor of a physical item associated with a monetary value, such as a paper money acceptor, coin acceptor, or a card reader. This acceptor may include a validator configured to identify the physical item, and determine whether the physical item is suitable as payment to the machine.

In some examples, machine 100 may also physically dispense a corresponding payout (e.g., cash), or otherwise facilitate the payout to the player (by adding funds to an electronic account associated with a gaming card). Such an activity may be triggered by a cash out button either on display 110 or elsewhere on machine 100. Additionally or alternatively to determining the payout amount, machine 100 may perform other actions to award the player. For instance, the machine may display an indication of a tangible prize. Other types of awards may be used as well.

For purposes of this description, any operation listed in a sentence including the words the “machine 100 can cause,” the “server machine 100a can cause,” or the “client machine 100b can cause” can be carried out, at least in part, as a result of that particular machine executing software program instructions. Those software program instructions can be stored within data storage 114, 114a, or 114b.

Data storage 114, 114a, and 114b can also store data. As an example, a global symbol group for a reel-based game may include multiple symbols, such as a Scatter, a Wild, an Ace, a King, a Queen, a Jack and a Ten that may be used in connection with the outcome event, such as a wager game. The Ace, King, Queen, Jack, and Ten symbols can represent symbols found on a standard deck of playing cards. The Wild symbol may have special properties that allow it to form winning combinations with other symbols. For instance, the Wild symbol may be substitutable for any other symbol, except for the Scatter symbol. The Scatter symbol may have special properties that allow it trigger an award when at least n (e.g., 3) Scatter symbols appear in a set of symbols. Further, the at least n Scatter symbols need not appear on a pay line in order to trigger an award.

However, such a global symbol group may be customized with particular symbols as desired. As some possible examples, the symbols may include images of people, animals, fanciful creatures, cartoon characters, inanimate objects, or other things in addition to or instead of Scatter, Wild, Ace, King, Queen, Jack, or Ten symbols. Furthermore, Wild symbols may vary in design. Examples of some possible symbols are shown in the accompanying drawings.

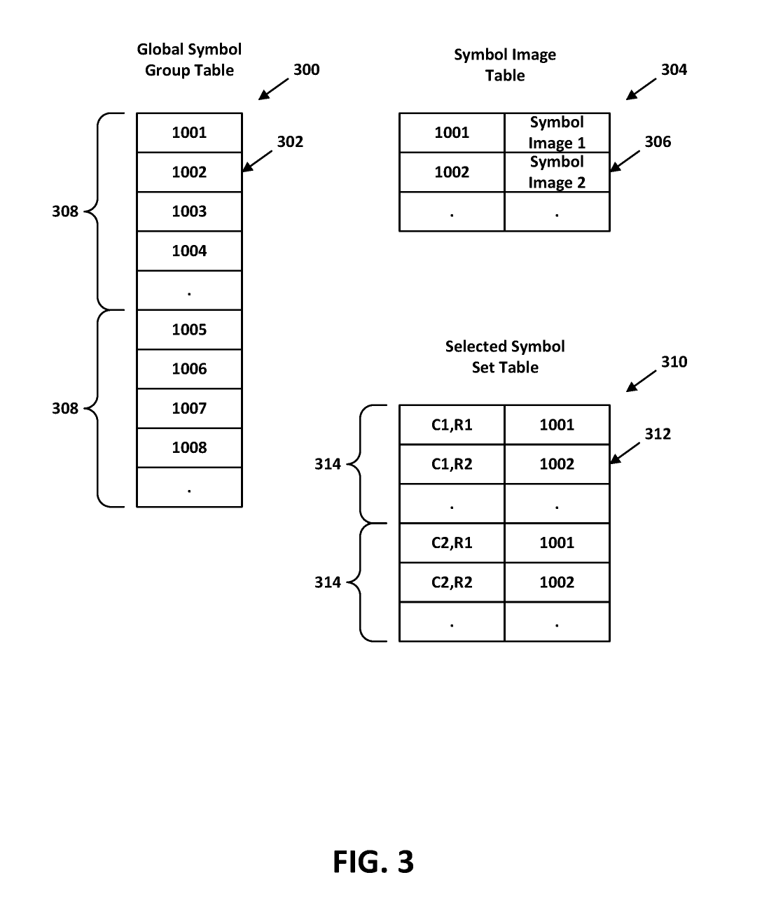

In one example, the global symbol group may be represented as a table (or other data structure) stored in data storage 114. FIG. 3 shows an example global symbol group table 300. The global symbol group table 300 includes multiple records 302, each including an identifier (e.g., 1001, 1002, 1003 1004, etc.) that represents a particular symbol. In one example, the global symbol group, and therefore the global symbol group table 300, may be divided into multiple sub-groups 308 as discussed in greater detail below.

The global symbol group table 300 may be used in connection with a symbol image table 304. The symbol image table 304 includes multiple records 306 (shown as distinct rows of table 304), each including an identifier that represents a particular symbol, and a corresponding displayable image. As such, the symbol image table 304 may be used to map an identifier in the global symbol group table 300 to a displayable image. Such an image may be arranged according to the Joint Photographic Experts Group (JPEG), Graphics Interchange Format (GIF), or Portable Network Graphics (PNG) encodings, for example.

During the course of a game, various symbol sets may be selected for display. Each selected symbol set may be stored in a table such as selected symbol set table 310. Selected symbol set table 310 includes multiple records 312 (shown as distinct rows in selected symbol set table 310), each record including an arrangement position of the symbol, and an identifier that represents the symbol. As such, each symbol in the selected symbol set may correspond with a respective arrangement position in a display arrangement (e.g., both a column number and a row number in a column-and-row arrangement). As an example, C1,R1, shown in the selected symbol set table 310, represents a symbol position at column 1 (e.g., a left-most column of a plurality of columns in a symbol-display-portion of display 110) and row 1 (e.g., a top row of a plurality of rows in a symbol-display-portion of display 110). The column identifiers in selected symbol set table 310 (e.g., C1 and C2) can refer to columns in a symbol matrix or reels of a plurality of reels that can be spun.

In one example, machine 100 may select the first symbol set by iterating through each record 312 in the selected symbol set table 310, and selecting a symbol identifier from among the symbol identifiers in the global symbol group table 300. In some examples, the symbol identifiers are numbers and machine 100 uses a random number generator to select such numbers, and therefore to randomly select symbols.

In some examples, machine 100 may select each subset in the first symbol set from the corresponding sub-group in the global symbol group. This type of selection may be used when the symbol set represents one or more reels in a reel-type wager game. In this instance, each sub-group includes all the symbols of a given reel, and the selected sub-set includes the symbols of the reel that are “in play,” namely those included in the selected symbol set.

In some examples, the selected symbol set may be partially restricted. For instance, the selected symbol set may include an instance of a predetermined symbol from the global symbol group, for example, a Wild symbol. In another example, the predetermined symbol may be in a subgroup of global symbol group table 300 distinct from the subgroups from which symbols for the reels are selected.

As noted above, for each symbol in the selected first symbol set, the example embodiments can include machine 100 randomly determining a corresponding arrangement position. As such, in an example where the arrangement is a column-and-row arrangement, machine 100 may randomly determine a column identifier and a row identifier (from a set of potential column identifier and row identifier combinations) for each symbol in the selected first symbol set. In an example where the arrangement has symbol position identifiers (e.g., whole number 1 through 15, inclusive, as described above), machine 100 may randomly select a symbol position identifier for each symbol in the selected first symbol set.

Where the column and row arrangement is used to simulate reels, machine 100 may display the each subset in a corresponding column, such as by superimposing each subset over a virtual reel in a corresponding column. Thus, a sub-group 308 may represent an ordering of symbols on a particular reel.

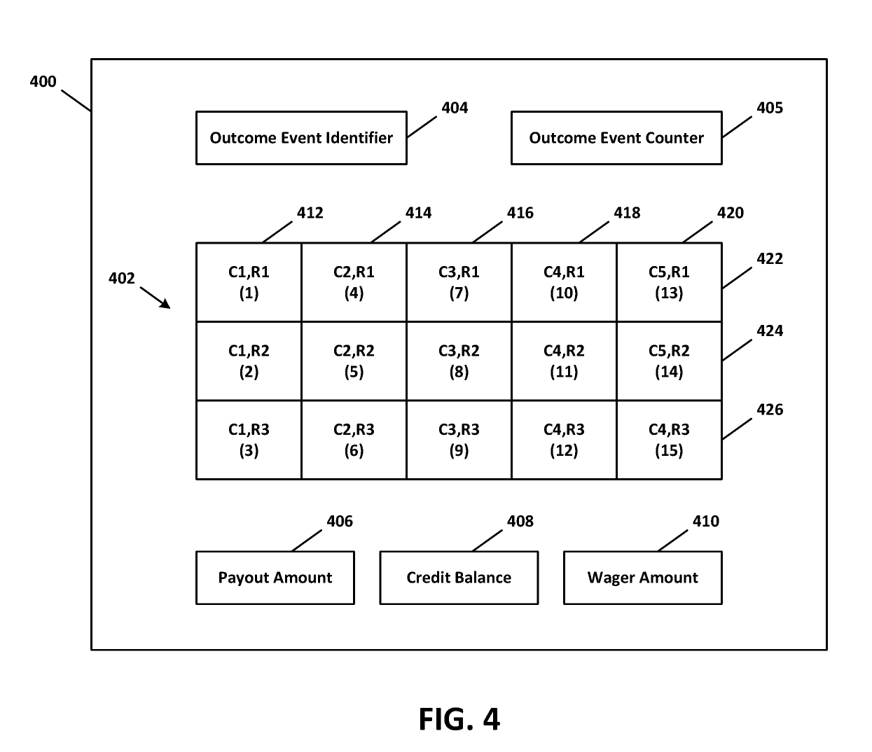

FIG. 4 depicts a screenshot 400 that machine 100, server machine 100a, or client machine 100b can visually present (i.e., display) using displays 110, 110a, and 110b, respectively. For purposes of this description, each element of screenshot 400 can be a displayable element of the display. Screenshot 400 includes a symbol-display-portion 402, an outcome event identifier 404, an outcome event counter 405, a payout amount indicator 406, a credit balance indicator 408, and a wager amount indicator 410.

Symbol-display-portion 402 can include multiple symbol-display-segments and multiple symbol positions. As an example, the symbol-display-segments can include vertical symbol-display-segments 412, 414, 416, 418, and 420 (or more simply, vertical SDSs 412-420). As another example, the symbol-display-segments can include horizontal symbol-display-segments 422, 424, and 426 (or more simply, horizontal SDSs 422-426). Each symbol-display-segment can include multiple symbol positions. The vertical SDSs 412-420 are shown in FIG. 4 as having three symbol positions. The horizontal SDSs 422-426 are shown in FIG. 4 as having five symbol positions. A person skilled in the art will understand that those symbol-display-segments can be configured with different numbers of symbol positions than shown in FIG. 4.

The vertical SDSs 412-420 can be configured as spinnable reels. The processor of a machine or system displaying screenshot 400 can display the spinnable reels spinning and stopped after spinning. For vertical SDSs 412-420, the spinnable reels may spin in a vertical direction (e.g., top to bottom or bottom to top, with respect to the symbol-display-portion 402).

The horizontal SDSs 422-426 can be configured as spinnable reels. The processor of a machine or system displaying screenshot 400 can display the spinnable reels spinning and stopped after spinning. For horizontal SDSs 422-426, the spinnable reels may spin in a horizontal direction (e.g., left to right or right to left, with respect to the symbol-display-portion 402).

Machine 100 can cause symbol-display-segments to spin, and cause spinning symbol-display-segments to stop spinning. The spinning and stopping of the spinning symbol-display-segments can be carried out for each outcome event. In accordance with the embodiments in which the symbol-display-portion 402 includes columns or reels that spin from top to bottom or bottom to top, spinning the reels can include starting the spinning from a left-most column or reel to a right-most column or reel. Stopping the reels can occur using a similar sequence. Other sequences of spinning and stopping the spinning can be used. Moreover, the spinning or stopping of spinning of two or more columns or reels could occur simultaneously.

The multiple symbol positions in symbol-display-portion 402 are identified by column and row designators, in which C1=column 1, C2=column 2, C3=column 3, C4=column 4, C5=column 5, R1=row 1, R2=row 2, and R3=row 3. The multiple symbol positions in symbol-display-portion 402 are also identified by distinct numerical identifiers shown within parenthesis. C1 can be a first SDS. C2 can be a second SDS. C3 can be a third SDS. C4 can be a fourth SDS. C5 can be a fifth SDS. As shown in FIG. 4, C2 is between C1 and C3, C3 is between C2 and C4, and C4 is between C3 and C5.

For a matrix arrangement with 15 symbol positions as shown in FIG. 4, the numerical identifiers can be whole numbers 1 through 15, inclusive. The processors or machines described herein can be configured to select a symbol position of symbol-display-portion 402 using a random number generator that is configured to generate a number within the range 1 through N, inclusive, where N equals the number of symbol positions in symbol-display-portion 402. For the matrix arrangement, each symbol-display-segment can be a distinct column of the multiple columns within the matrix. Alternatively, for the matrix arrangement, each symbol-display-segment can be a distinct row of the multiple rows within the matrix.

The processor of the machines or systems described herein can determine a state the machine or system is operating in or an outcome event that can occur during the determined state of the machine or system. In response to making that determination, the processor can cause the outcome event identifier 404 to display an identifier of the outcome event that can occur during the determined state. For example, the outcome event identifier can identify a base outcome event, a bonus outcome event or another type of outcome event. The bonus outcome event can be a “free spins” outcome event or some other outcome event.

The processor of the machines or systems described herein can determine a wager amount placed on an outcome event, a payout amount after or during occurrence of an outcome event resulting in a win, a credit balance after or while decreasing a number of credits based on placement of a wager or after or while increasing a number of credits based on a determined payout amount, and a number of awarded remaining outcome events that can occur. The processor can cause the determined wager amount to be displayed by the wager amount indicator 410, the determined payout amount to be displayed by the payout amount indicator 406, the determined credit balance to be displayed by the credit balance indicator 408, and the number of awarded remaining outcome events to be displayed by the outcome event counter 405.

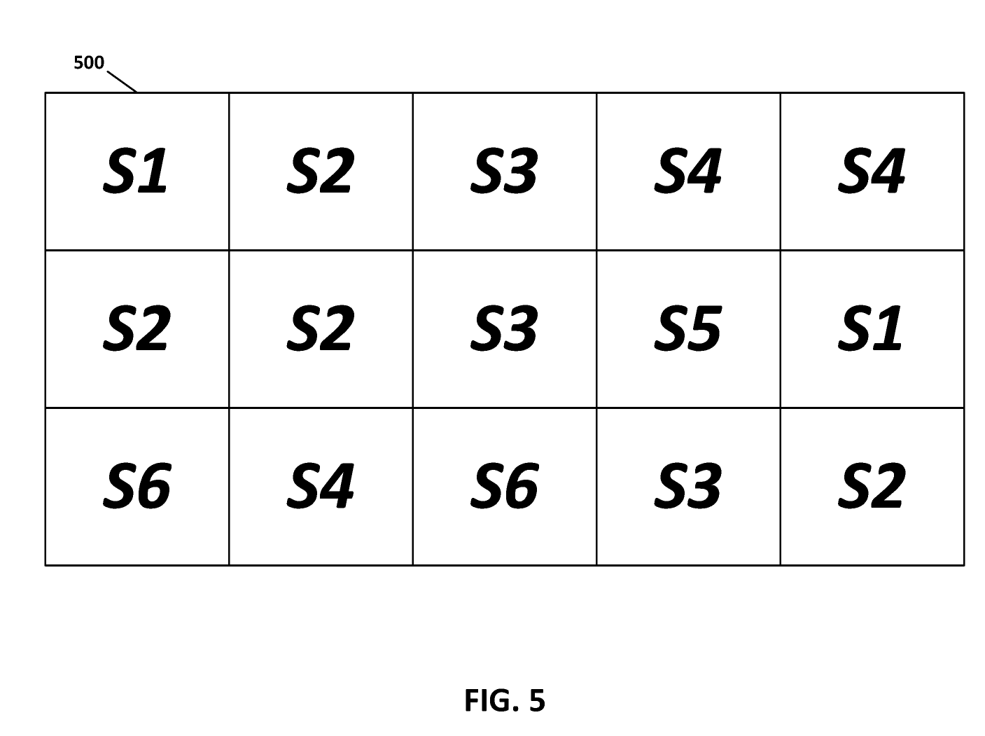

FIG. 5 shows an example of a selected symbol set 500 from the global symbol group for display during a base or bonus outcome event. The selected symbol set 500 includes (i) symbol S1 at arrangement positions C1,R1 and C5,R2, (ii) symbol S2 at arrangement positions C2,R1, C1,R2, C2,R2, and C5,R3, (iii) symbol S3 at arrangement positions C3,R1, C3,R2, and C4,R3, (iv) symbol S4 at arrangement positions C4,R1, C5,R1, and C2,R3, (v) symbol S5 at arrangement position C4,R2, and (vi) symbol S6 at arrangement positions C1,R3, and C3,R3. Other arrangements of symbols, in terms of the number of columns, number of rows, or the layout of symbols, are possible.

### III. Example Reel-Based Bonus Game

During a reel-based bonus game, the appearance of a particular number (e.g., 3) of trigger symbols within a bonus outcome event may trigger the award of additional bonus outcome events (e.g., free spins). Any trigger symbol that appears during play of the reel-based bonus game may be locked-down until sufficient trigger symbols accumulate to trigger that award of additional bonus outcome events. For instance, the locked-down trigger symbols from a first bonus outcome event may persist and/or reappear at a same position on a further bonus outcome event. Furthermore, in some cases, before sufficient trigger symbols have accumulated, all locked-down (i.e. old) trigger symbols may adopt the functionality of Wild symbols for purposes of determining a payout, if any.

In one example, when an award of additional bonus outcome events is triggered due to the appearance of sufficient trigger symbols within a bonus outcome event, all locked-down (i.e. old) trigger symbols may be released and might not play any part in the determination of a payout if any. In some cases, any new trigger symbols that were not previously locked-down due to appearance of the trigger symbol in a prior bonus outcome event may adopt the functionality of Wild symbols for purposes of determining a payout, if any. These features are described in the stage diagram of Table 1, where the states represent bonus outcome events.

TABLE 1

| State | Action |
|---|---|
| No trigger symbols | N/A |
| no locked-down (old) | Lock down new trigger |
| trigger symbols | symbols; new |
| and <n new | trigger symbols |
| trigger symbols | temporarily |
| | adopt Wild |
| | functionality |
| n₁ old trigger symbols | Lock down new |
| and n₂ new | trigger symbols; |
| trigger symbols, | new and old |
| where n₁ + n₂ < n | trigger symbols |
| | temporarily |
| | adopt Wild |
| | functionality |
| ≥n new trigger | Award bonus outcome |
| symbols and no | events; new trigger |
| old trigger symbols | symbols do not adopt |
| | Wild functionality |
| n₁ old trigger | Release all old trigger |
| symbols and n₂ | symbols; award bonus |
| new trigger symbols, | outcome events; |
| where n₁ + n₂ ≥ n | new trigger symbols |
| | adopt Wild functionality; |
| | old trigger symbols |
| | do not adopt Wild |
| | functionality |

Alternatively, in another example, when an award of additional bonus outcome events is triggered due to the appearance of sufficient trigger symbols within a bonus outcome event, all trigger symbols (including any new trigger symbols and locked-down trigger symbols) may adopt the functionality of Wild symbols for purposes of determining a payout, if any.

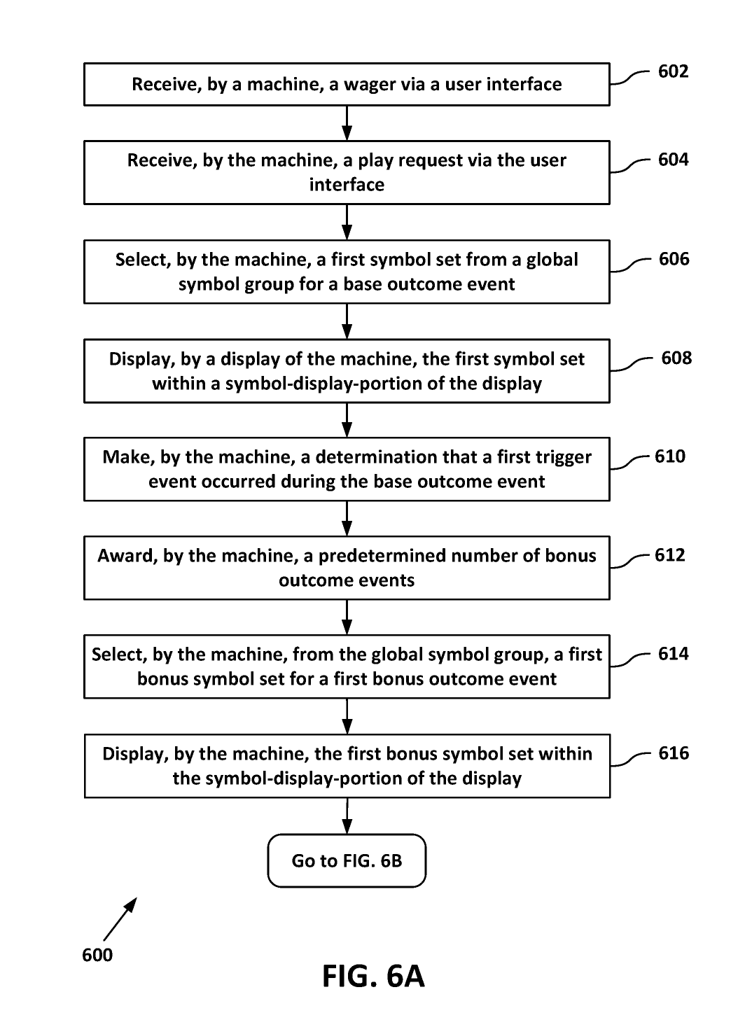

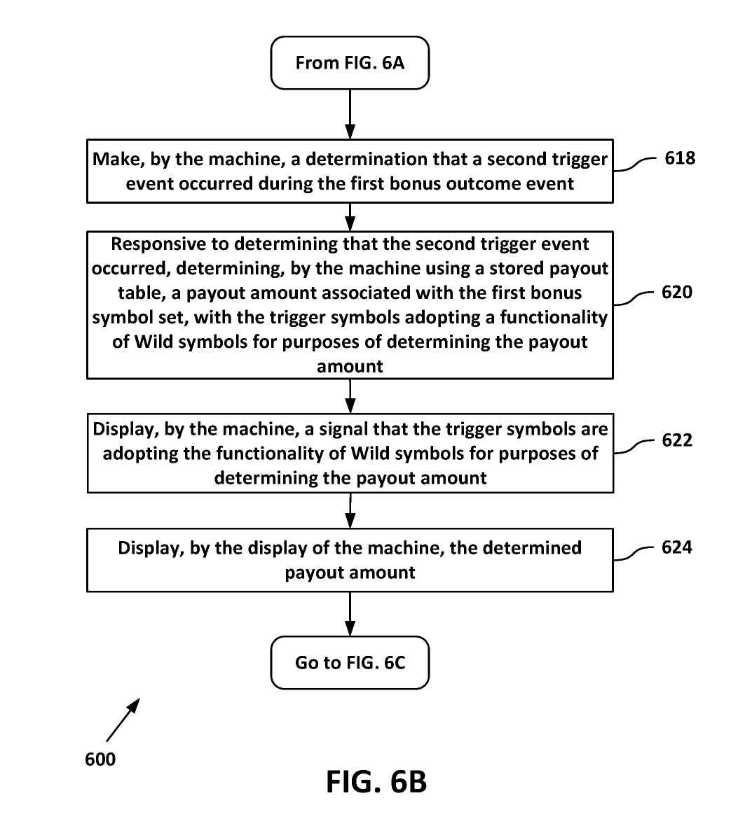

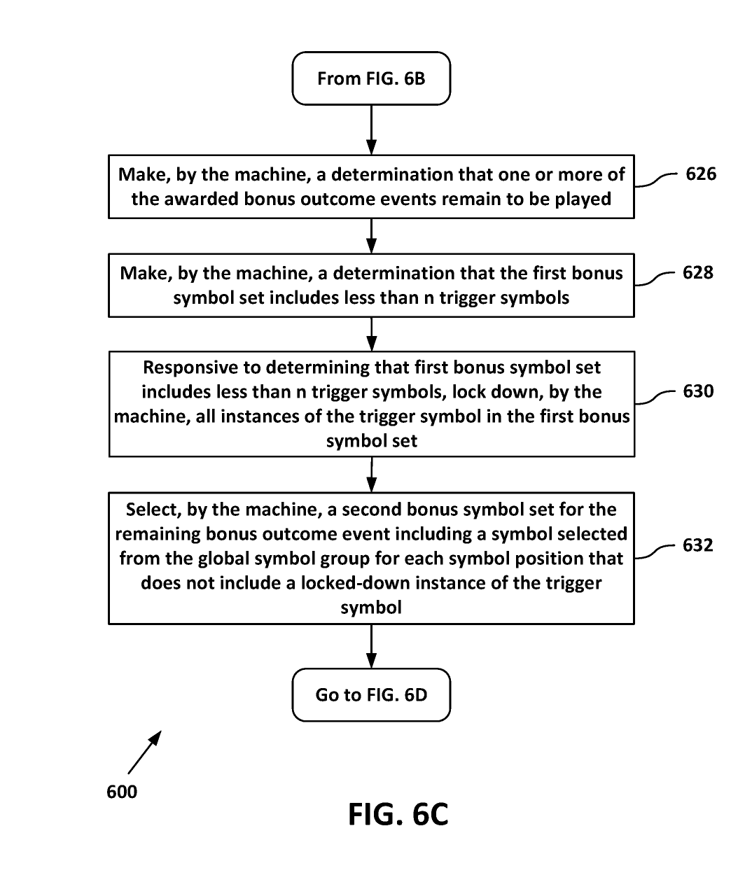

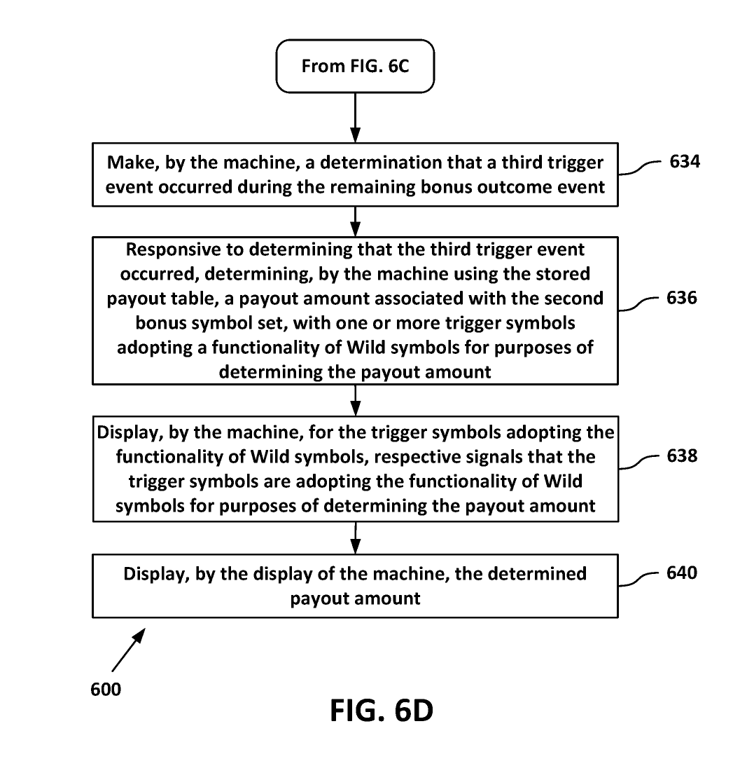

FIGS. 6A-6D depict a flow chart showing a set of operations 600 (or more simply, “the set 600”) that can, for example, be carried out using machine 100. Nonetheless, some or all of these operations may be carried out on server machine 100a and/or client machine 100b.

The operations of the set 600 are shown within blocks labeled with even integers between 602 and 640, inclusive, and can pertain to a method in connection with machine 100. The example method can relate to performing outcome events, such as a wager game. Any other operation(s) described herein as being performed by machine 100 can be performed prior to, while, or after performing any one or more of the operations of the set 600, unless context clearly dictates otherwise. Those other operation(s) can be performed in combination with or separately from any one or more of the operations of the set 600. Any operation described below, or elsewhere in this description, with respect to FIGS. 6A-6D, can be performed, at least in part, by a processor, such as processor 112 executing software program instructions.

Turning to FIG. 6A, block 602 includes receiving, by machine 100, a wager via the user interface 104. In one example, this may allow a player to enter a wager (e.g., a wager amount) using a keypad of the user interface 104. The wager can be placed on an outcome event, such as, but not limited to, a base outcome event configured as a wager game. The received wager may or may not provide a user of the machine with an opportunity to earn (e.g., win) a payout. Since a received wager does not necessarily provide an opportunity to earn a payout, the received wager can be referred to as a payment. A base outcome event can be carried out after or in response to receiving a payment. Machine 100 can be configured such that a bonus outcome event can be carried out without receiving any additional payment after receiving a payment to carry out a base outcome event that results in an award of a number of bonus outcome events.

A player using machine 100 may have a corresponding player credit balance, from which the entered wager may be deducted in response to the wager being entered or machine 100 receiving a play request from the player. For example, a player may have a player credit balance of 100,000 credits, which may be reduced to 99,750 credits upon the player requesting a play of the game with a wager of 250 credits. Additionally or alternatively, the wager can be received by entry of a token, coin, or paper bill into the user interface 104 or by sliding or inserting a payment card, such as a credit or debit card, into the user interface 104. Machine 100 can cause display 110 to display wager information such as, but not limited to, a player credit balance on the credit balance indicator 408 and a received wager amount in wager amount indicator 410.

Next, block 604 includes receiving, by machine 100, a play request (e.g., a “spin” request) via the user interface 104. Receiving the play request can include or allow a player to pull a lever or push a button on machine 100 to initiate occurrence of an outcome event or to request a play of the wager game. Receiving the play request can result in the player's credit balance being reduced by an amount of the player's wager or a payment to carry out the outcome event.

Next, block 606 includes selecting, by machine 100, a first symbol set to display within the symbol-display-portion 402 of display 110 for the base outcome event. Determining the first symbol set can include processor 112 carrying out a random selection, such as a random selection of the first symbol set from a global symbol group.

Next, block 608 includes displaying, by the machine 100 on the symbol-display-portion of the display 110, the selected first symbol set.

Next, block 610 includes making, by machine 100, a determination that a first trigger event occurred during the base outcome event. The trigger event can be a randomly occurring event, such as an event that randomly occurs during performance of at least some base outcome events. For example, occurrence of the trigger event can include the presence of at least one trigger symbol in the first symbol set, such as in connection with a previous play of the game (e.g., a base outcome event). Similar to the selection of the first symbol set, in one example, machine 100 may use a random number generator to select the trigger symbol from the global symbol group. In another example, the trigger symbol may be non-randomly selected, such as selecting by a user (e.g. a player, machine designer or casino personnel). In another example, the trigger symbol may be predetermined, for example a Wild symbol.

Making the determination that the trigger event occurred can take place while machine 100 operates in a first machine state (or more simply, the first state). Machine 100 can be configured such that, while machine 100 is operating in the first state, machine 100 allows the player to play base outcome events in which sets of symbols selected from a global symbol group can be selected by processor 112 and displayed by display 110.

Next, block 612 includes, responsive to machine 100 making the determination (i.e., the determination made at block 610), awarding, by machine 100, a bonus feature of the game. For example, the bonus feature may be a predetermined number of consecutive plays (e.g., spins and/or patterns of symbols being displayed) of outcome events. The awarded outcome events can be bonus outcome events, such as a game or a wager game. The predetermined number of consecutive outcome events can be conditioned upon a combination of symbols displayed by display 110 as a result of playing a base outcome event. Machine 100 can cause outcome event identifier 404 to identify the bonus outcome event awarded (e.g., a “free spins” bonus) and to cause the outcome event counter 405 to display the predetermined number.

Furthermore, in response to making the determination at block 610, machine 100 can transition from operating in the first state to operating in a second machine state (or more simply, the second state). Machine 100 can be configured such that, while machine 100 is operating in the second state, machine 100 allows the player to play bonus outcome events in which sets of symbols selected from a global symbol group can be selected by processor 112 and displayed by display 110. In accordance with an embodiment in which the symbol-display-portion includes 15 symbol positions, selecting a set of symbols for a bonus outcome event can include selecting 15 symbols.

Machine 100 can be configured to transition from operating in the second state back to operating in the first state. This transition can occur in response to machine 100 determining any of a variety of trigger events, such as, but not limited to, occurrence of all of the awarded predetermined number of consecutive plays of the outcome event, or a player stopping play of machine 100 while one or more of the awarded predetermined number of consecutive plays of the outcome event remain to occur. Machine 100 can be configured to store a number indicating any remaining consecutive plays of the outcome event and to allow a player awarded the consecutive plays to commence playing any remaining consecutive plays of the outcome event at a time after the player stops performing (e.g., playing) the outcome events.

Next, block 614 includes selecting, by the machine 100 from the global symbol group, a first bonus symbol set for a first bonus outcome event.

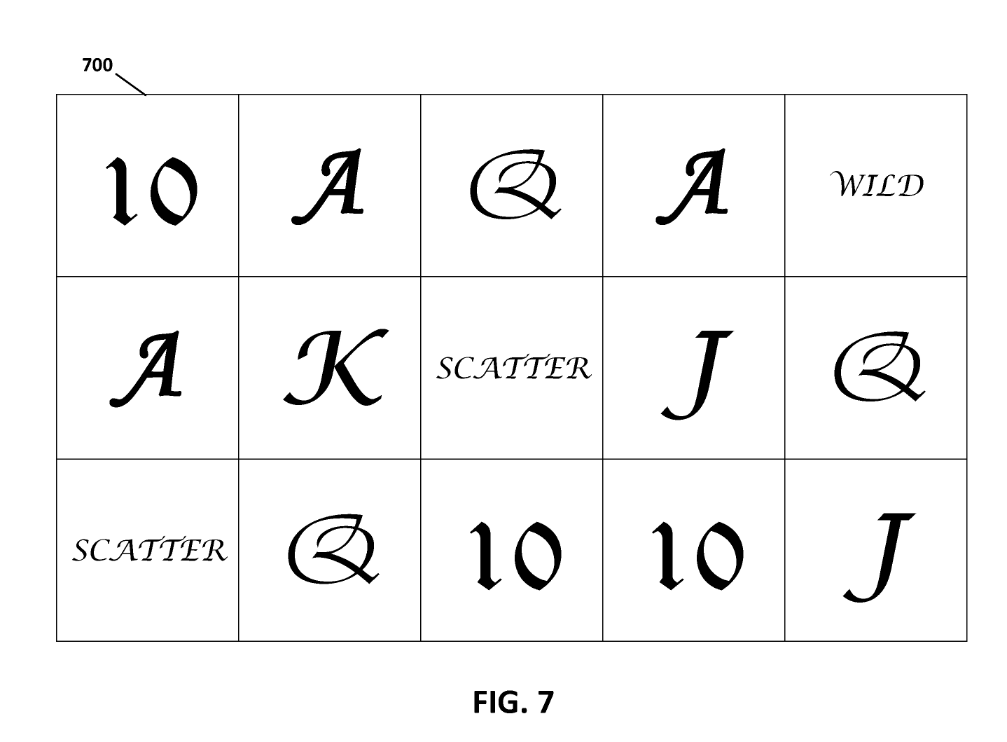

Next, block 616 includes displaying, by the machine 100 on the symbol-display-portion of the display 110, the selected first bonus symbol set. FIG. 7 shows an example of a first bonus symbol set 700 from the global symbol group for display during a bonus outcome event. The displayed first bonus symbol set 700 includes (i) a single Wild symbol at arrangement position C5,R1; (ii) three Ace symbols at arrangement positions C1,R2, C2,R1, and C4,R1; (iii) a King symbol at arrangement position C2,R2; (iv) three Queen symbols at arrangement positions C2,R3, C3,R1, and C5,R2; (v) a pair of Jack symbols at arrangement positions C4,R2 and C5,R3; (vi) three Ten symbols at arrangement positions C1,R1, C3,R3, and C4,R3; and (vii) two Scatter symbols at arrangement positions C1,R3 and C3,R2.

Turning to FIG. 6B, block 618 includes making, by machine 100, a determination that a second trigger event occurred during the first bonus outcome event. The trigger event can be a randomly occurring event, such as an event that randomly occurs during performance of at least some bonus outcome events. For example, occurrence of the trigger event can include the presence of at least one trigger symbol in the first bonus symbol set. Similar to the selection of the first bonus symbol set, in one example, machine 100 may use a random number generator to select the trigger symbol from the global symbol group. In another example, the trigger symbol may be non-randomly selected, such as selecting by a user (e.g. a player, machine designer or casino personnel). In another example, the trigger symbol may be predetermined, for example a Scatter symbol.

Next, block 620 includes, responsive to machine 100 determining, at block 618, that the second trigger event occurred, determining, by the machine 100 using a stored payout table, a bonus payout amount associated with the first bonus symbol set. The payout amount may be determined by the machine 100 using a stored payout table (not shown) as a function of the received wager and the symbols in the first bonus symbol set. For purposes of determining the payout amount, the trigger symbols may adopt the functionality of Wild symbols. In particular, for purposes of determining the payout amount, the trigger symbols may adopt the ability to be substitutable for other symbols in the reel-based game, other than Scatter symbols. Note that because the bonus outcome event is the first bonus outcome event, all of the trigger symbols are new trigger symbols that were not previously locked-down.

Next, block 622 includes, displaying, by the machine 100, a signal that the trigger symbols are adopting the functionality of Wild symbols for purposes of determining the payout amount. The display 110 may display such a signal by highlighting, shading, hatching, or adding a border around the corresponding trigger symbols, but other indication techniques may also be used. In one example, the machine 100 may temporarily display the word “Wild” over the trigger symbols. In another example, the machine 100 may temporarily replace the trigger symbols with Wild symbols.

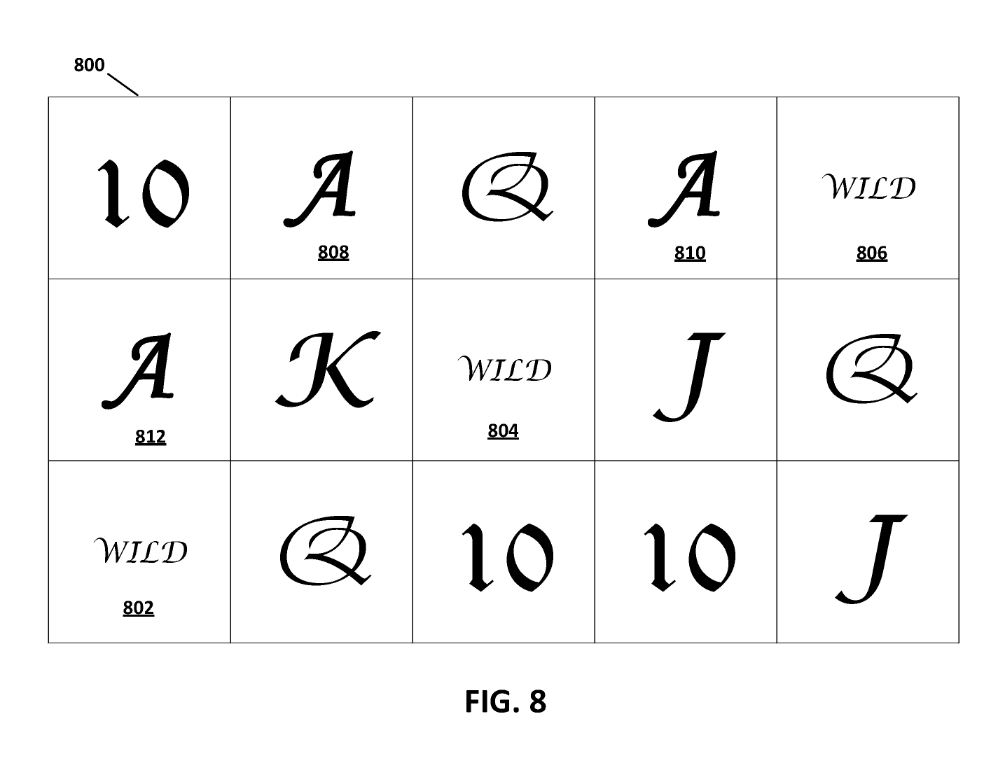

FIG. 8 shows an example of trigger symbols of the first bonus symbol set 700 of FIG. 7 adopting the functionality of Wild symbols. In particular, as illustrated in the modified bonus symbol set 800 of FIG. 8, the Scatter symbols previously shown at arrangement positions C1,R3 and C3,R2 in FIG. 7 have temporarily adopted the functionality of Wild symbols 802 and 804.

As discussed above, in some cases, treating the Scatter symbols of the first bonus symbol set 700 as Wild symbols may enhance any payout associated with the displayed symbols. For instance, in the modified bonus symbol set 800, Wild symbol 802 or Ace symbol 812, Ace symbol 808, Wild symbol 804, Ace symbol 810, and Wild symbol 806 form a winning combination of five Aces (one Ace appearing in each column), since a Wild symbol may substitute for any other symbol in the global symbol group. These winning combinations are not present in the first bonus symbol set 700.

Referring back to FIG. 6B, block 624 includes displaying, on the display 110, the determined payout amount. For example, where machine 100 has determined, using the stored payout table, a payout amount of 500 credits, machine 100 may display on display 110 the determined payout amount of 500 credits. Additionally or alternatively, machine 100 may add the determined payout amount to the player credit balance and display the updated player credit balance. For instance, where the player credit balance was 99,750 credits before the payout amount was determined, machine 100 may add the determined payout amount of 500 credits to the player credit balance so that the updated balance is 100,250 credits. Furthermore, machine 100 can cause display 110 to display a count-up from a first balance amount (e.g., 99,750 credits) to a second balance amount (e.g., 100,250 credits), where the second balance amount equals a sum of the first balance amount and the determined payout amount.

In one example, the machine 100 may also physically dispense a corresponding payout amount (e.g., cash), or otherwise facilitate the payout to the player (by adding funds to an electronic account associated with a gaming card). Additionally or alternatively to determining the payout amount, machine 100 may perform other actions to award the player. For instance, the machine may display an indication of a tangible prize. Other types of awards may be used as well.

After the trigger symbols have adopted the functionality of Wild symbols for purposes of determining any payout, the trigger symbols may revert back and abandon the adopted functionality for purposes of carrying out any remaining bonus outcome events.

Turning to FIG. 6C, block 626 includes making, by machine 100 (e.g., processor 112), a determination that one or more of the awarded bonus outcome events remain to be played. In that regard, processor 112 may determine one or more awarded bonus outcome events have not occurred by referring to data within data storage 114 that is displayed at bonus outcome event counter 405 shown in FIG. 4. An awarded bonus outcome event that has not yet occurred can be referred to as a “remaining bonus outcome event”.

Next, block 628 includes making, by machine 100, a determination that the first bonus symbol set includes less than n trigger symbols.

Next, block 630 includes, responsive to machine 100 determining, at block 628, that the first bonus symbol set includes less than n trigger symbols, locking down, by machine 100, all instances of the trigger symbol in the displayed first bonus symbol set. As an example, processor 112 may execute program instructions to “lock down” all instances of the trigger symbol. In one example, each symbol to be locked down may persist in the same arrangement position of the symbol-display-portion of the display 110. For instance, referring back to FIG. 7, machine 100 may lock down instances of the trigger symbol appearing at arrangement positions C1,R3 and C3,R2 in the first bonus symbol set 700.

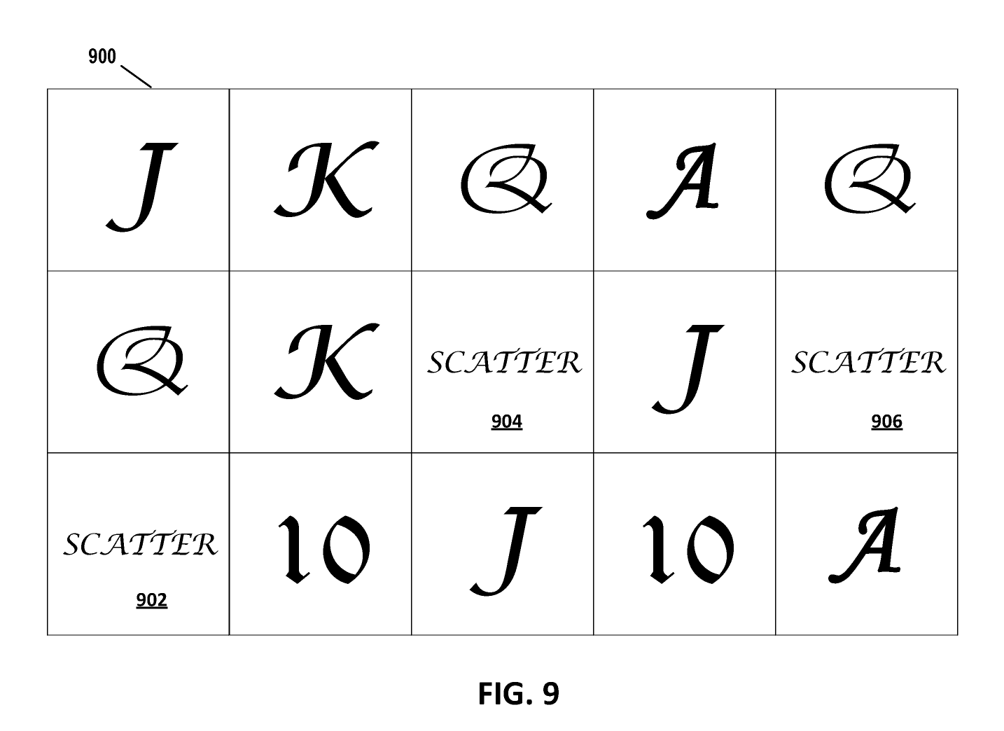

Next, block 632 includes selecting, by machine 100, a second bonus symbol set to display within the symbol-display-portion 116 of display 100. The second bonus symbol set can include a symbol selected from the global symbol group for each arrangement position within the symbol-display-portion 116 excluding each arrangement position with a locked down instance of the predetermined symbol. FIG. 9 shows an example of a second bonus symbol set 900 selected from the global symbol group for displaying during a remaining (e.g., a next) bonus outcome event occurring after the bonus outcome event represented by FIG. 7. Second bonus symbol set 900 includes two Scatter symbols 902 and 904 at respective arrangement positions C1,R3 and C3,R2. Scatter symbols 902 and 904 have persisted from the previous first bonus symbol set 700 in the same arrangement position. Scatter symbol 906 has been newly selected as part of the second bonus symbol set 900.

Turning to FIG. 6D, block 634 includes making, by machine 100, a determination that a third trigger event occurred during the remaining bonus outcome event. As discussed above, the trigger event can be a randomly occurring event, such as an event that randomly occurs during performance of at least some bonus outcome events. For example, occurrence of the trigger event can include the presence of at least one new trigger symbol in the second bonus symbol set.

Next, block 636 includes, responsive to machine 100 determining, at block 634, that the third trigger event occurred, determining, by the machine 100 using the stored payout table, a payout amount associated with the second bonus symbol set. The payout amount may be determined by the machine 100 using a stored payout table (not shown) as a function of the received wager and the symbols in the second bonus symbol set.

For purposes of determining the payout amount, one or more trigger symbols in the second bonus symbol set may adopt the functionality of Wild symbols and temporarily become substitutable for other symbols in the reel-based game, other than Scatter symbols. In one example, the question of which trigger symbols adopt the functionality of Wild symbols may depend on the total number of trigger symbols in the second bonus symbol set in relation to a predetermined number of trigger symbols, n. If the total number of trigger symbols is less than n, all of the trigger symbols may adopt the functionality of Wild symbols. Whereas, if the total number of trigger symbols is greater than or equal to n, the new trigger symbols in the second bonus symbol set may adopt the functionality of Wild symbols, but the old trigger symbols (locked-down from the first bonus symbol set) do not adopt the functionality of Wild symbols.

Alternatively, in another example, all trigger symbols in the second bonus symbol set may adopt the functionality of Wild symbols for purposes of determining the payout amount regardless of the total number of trigger symbols in the second bonus symbol set.

Next, block 638 includes, displaying, by the machine 100, for the trigger symbols adopting the functionality of Wild symbols, respective signals that the trigger symbols are adopting the functionality of Wild symbols for purposes of determining the payout amount. The display 110 may display such a signal by highlighting, shading, hatching, or adding a border around the corresponding trigger symbols, but other indication techniques may also be used. In one example, the machine 100 may temporarily display the word “Wild” over the trigger symbols that are not locked in place. In another example, the machine 100 may temporarily replace the trigger symbols that are not locked in place with Wild symbols.

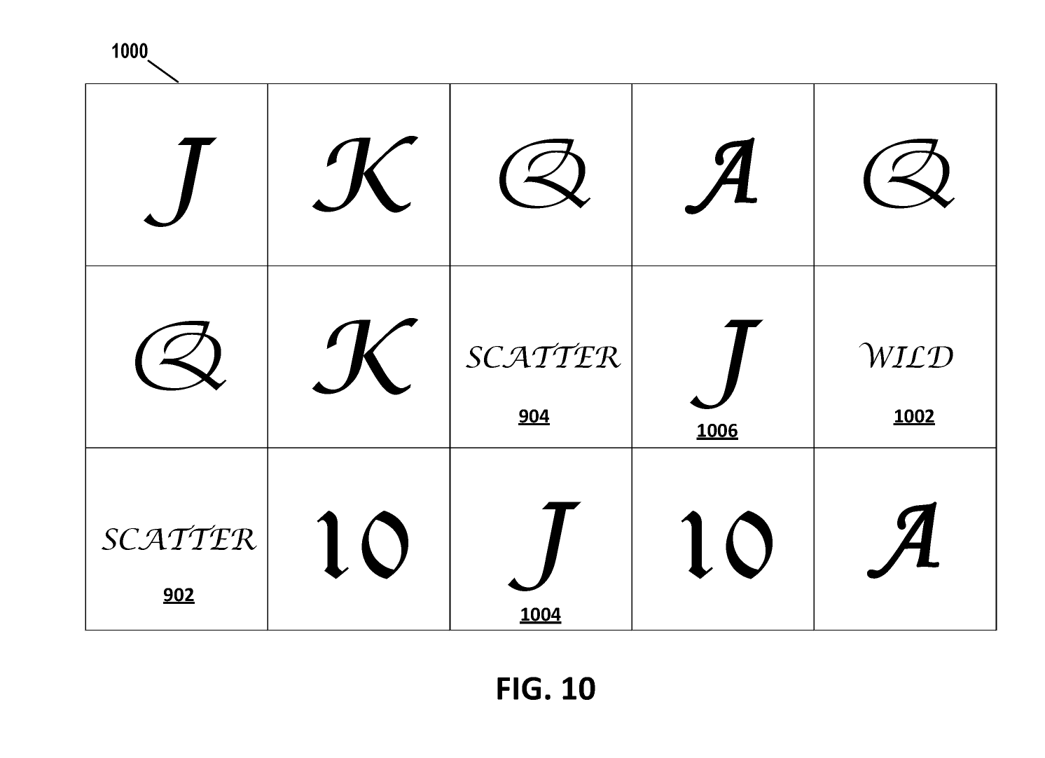

FIG. 10 shows an example of trigger symbols of the second bonus symbol set 900 of FIG. 9 adopting the functionality of Wild symbols. In particular, as illustrated in the modified bonus symbol set 1000 of FIG. 10, in an example where n=3, the new Scatter symbol 906 previously shown at arrangement position C5,R2 in FIG. 9 has temporarily adopted the functionality of Wild symbol 1002. Because the number of Scatter symbols in the second bonus symbol set of FIG. 9 is equal to n, the old Scatter symbols 902 and 904 do not adopt the functionality of Wild symbols.

As discussed above, in some cases, treating the new Scatter symbol 906 as a Wild symbol may enhance any payout associated with the displayed symbols. For instance, in the modified bonus symbol set 1000, Jack symbol 1004, Jack symbol 1006, and Wild symbol 1002 form a winning combination of three jacks (one Jack appearing in each column), since a Wild symbol may substitute for any other symbol in the global symbol group. This winning combination is not present in the second bonus symbol set 900.

Referring back to FIG. 6D, block 640 includes displaying, on the display 110, the determined payout amount. For example, where machine 100 has determined, using the stored payout table, a payout amount of 500 credits, machine 100 may display on display 110 the determined payout amount of 500 credits. Additionally or alternatively, machine 100 may add the determined payout amount to the player credit balance and display the updated player credit balance. For instance, where the player credit balance was 99,750 credits before the payout amount was determined, machine 100 may add the determined payout amount of 500 credits to the player credit balance so that the updated balance is 100,250 credits. Furthermore, machine 100 can cause display 110 to display a count-up from a first balance amount (e.g., 99,750 credits) to a second balance amount (e.g., 100,250 credits), where the second balance amount equals a sum of the first balance amount and the determined payout amount.

In one example, the machine 100 may also physically dispense a corresponding payout amount (e.g., cash), or otherwise facilitate the payout to the player (by adding funds to an electronic account associated with a gaming card). Additionally or alternatively to determining the payout amount, machine 100 may perform other actions to award the player. For instance, the machine may display an indication of a tangible prize. Other types of awards may be used as well.

After any trigger symbols have adopted the functionality of Wild symbols for purposes of determining any payout, the trigger symbols may revert back and abandon the adopted functionality for purposes of carrying out any remaining bonus outcome events.

In some embodiments, the set 600 can further include determining, by the machine 100, that that the second bonus symbol set includes at least n trigger symbols. Further, in response to determining that the second bonus symbol set includes at least n trigger symbols, the machine 100 can carry out various operations. For instance, machine 100 can award additional bonus outcome events. In some cases, the number of additional bonus outcome events may depend on the number of trigger symbols appearing in the second bonus symbol set. Additionally or alternatively, the machine 100 can unlock all locked in place trigger symbols in the second bonus symbol. Thus, in future bonus outcome events, new symbols can be selected for the arrangement positions where trigger symbols were previously locked in place.

In embodiments where the second bonus symbol set does not include at least n trigger symbols, functions of the set 600 can repeat to carry out each remaining bonus outcome event in response to machine 100 making the determination of block 626.

Notably, the operations of replacing, reordering, adding, and/or removing symbols from a reel of a reel-based game without spinning the reels, necessitate computer implementation. In a mechanical reel-based game, the symbols appearing on each reel are fixed and cannot be changed mid-game. In contrast, the computer implementation herein allows the number of symbols per reel to be changed, as well as the symbols appearing on each reel to be replaced and/or re-ordered. These changes can occur mid-game, for example between spins of the reels. Consequently, these features of the disclosure herein would not exist but for computer technology.

Particularly, the embodiments herein solve a technical problem of how to add movement to individual symbols of a reel-based game. The operations of replacing, reordering, adding, and/or removing symbols from a reel would be prohibitively complex and expensive to implement on a traditional machine with mechanical reels.

Further, these features are an improvement to reel-based gaming technology. Since the symbols appearing on each reel are fixed and cannot be changed mid-game in mechanical reel-based games, the operations of replacing, reordering, adding, and/or removing symbols from a reel could not appear in such games. Due to this technological limitation, players may become disinterested in these basic reel-based games. Computer implementation, however, facilitates the integration of these features into reel-based games, resulting in game dynamics that would otherwise be unavailable. Consequently, the disclosure herein is a technological improvement to reel-based games.

### IV. Example Operations

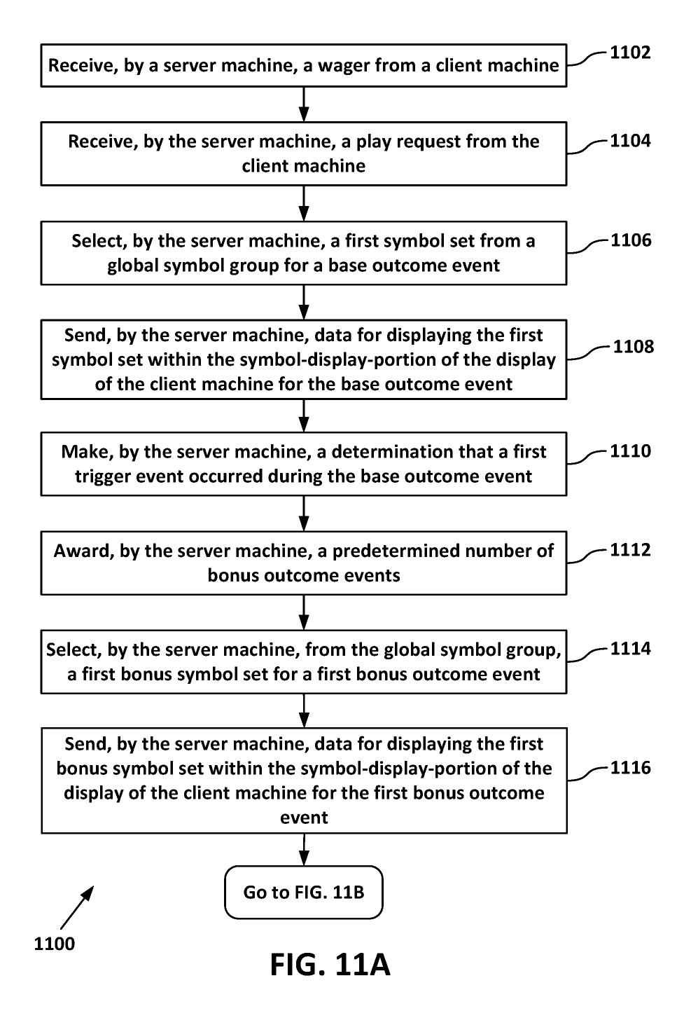

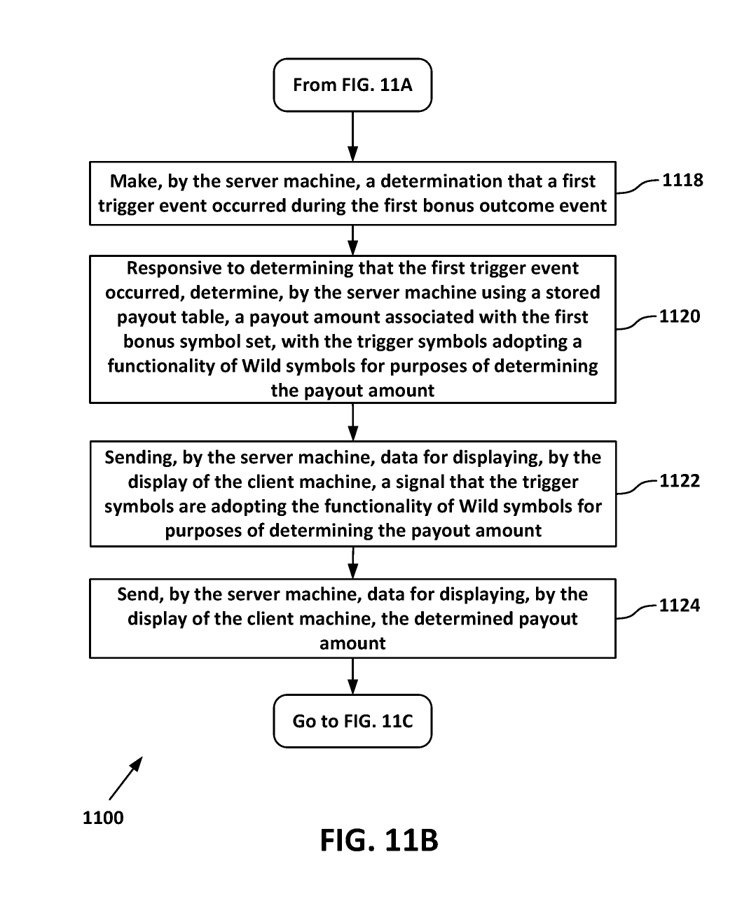

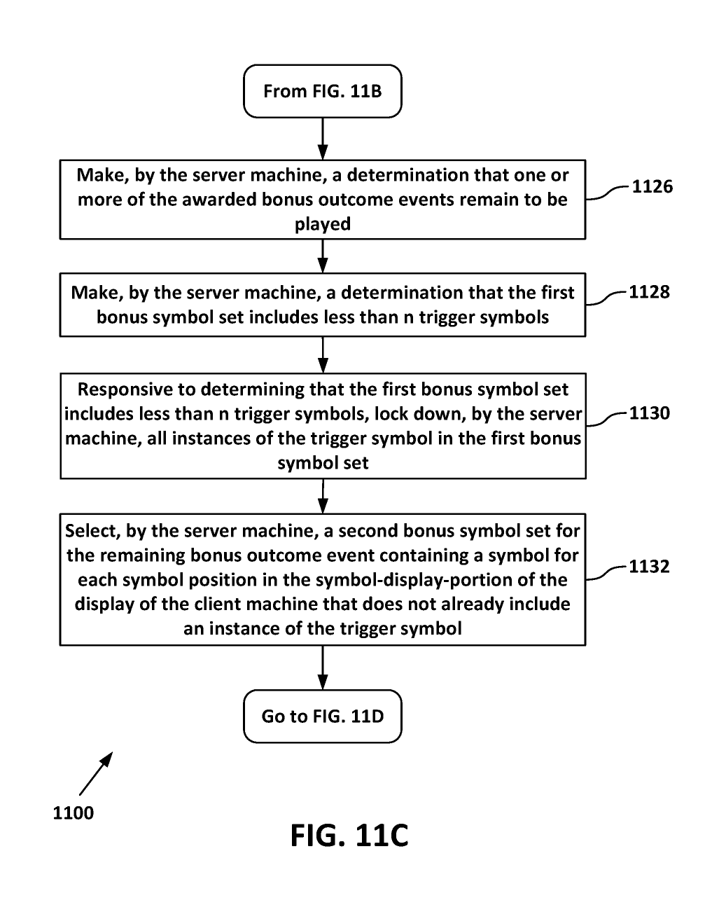

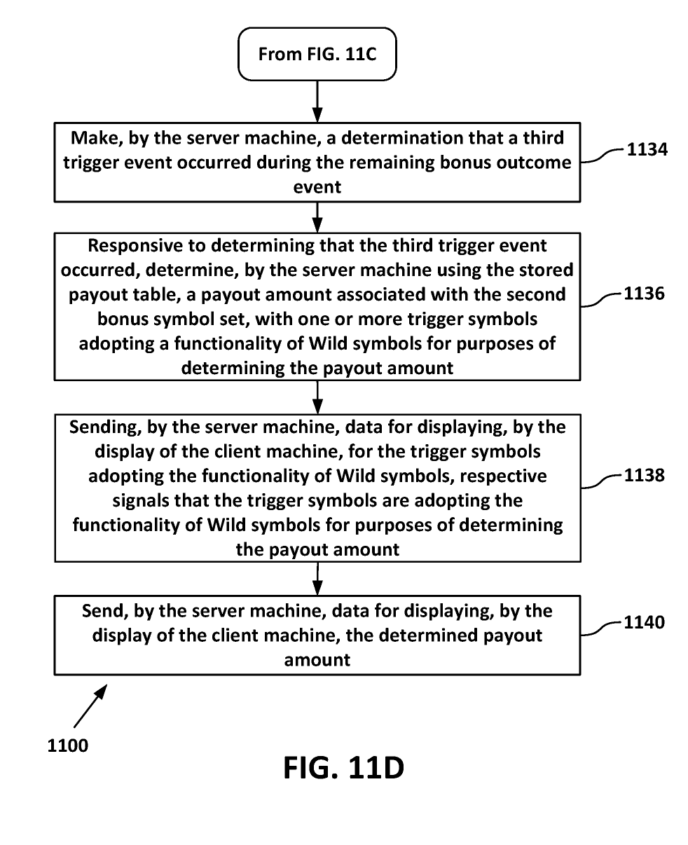

FIGS. 11A-11D depict a flowchart showing a set of operations 1100 (or more simply, “the set 1100”) that can, for example, be carried out using server machine 100a. Note that several of the operations described in connection with FIGS. 11A-11D parallel operations described in connection with FIGS. 6A-6D. As such, variations of the operations described in connection with FIGS. 6A-6D are likewise applicable to the operations described in connection with FIGS. 11A-11D. However, for the sake of brevity, these variations are not repeated. The server machine 100a, in performing the set 1100, can perform the operations described above with respect to machine 100.

Turning to FIG. 11A, block 1102 includes receiving, by the server machine 100a, a wager from the client machine 100b.

Next, block 1104 includes receiving, by the server machine 100a, a play request from the client machine 100b.

Next, block 1106 includes selecting, by the server machine 100a, a first symbol set to display within the symbol-display-portion of the display 110b of the client machine 100b for a base outcome event.

Next, block 1108 includes sending, by the server machine 100a, data for displaying the first symbol set within the symbol-display-portion 110b of the display 110b of the client machine 100b for the base outcome event.

Next, block 1110 includes making, by the server machine 100a, a determination that a first trigger event occurred during the base outcome event.

Next, block 1112 includes awarding, by the server machine 100a, a predetermined number of bonus outcome events.

Next, block 1114 includes selecting, by the server machine 100a, from the global symbol group, a first bonus symbol set for a first bonus outcome event.

Next, block 1116 includes sending, by the server machine 100a, data for displaying the first bonus symbol set within the symbol-display-portion of the display 110b of the client machine 100b for the first bonus outcome event.

Turning to FIG. 11B, block 1118 includes making, by the server machine 100a, a determination that a second trigger event occurred during the first bonus outcome event. For example, occurrence of the trigger event can include the presence of at least one trigger symbol in the first bonus symbol set.

Next, block 1120 includes responsive to determining that the second trigger event occurred, determining, by the server machine 100a using a stored payout table, a payout amount associated with the first bonus symbol set. For purposes of determining the payout amount, the trigger symbols may adopt the functionality of Wild symbols. In particular, for purposes of determining the payout amount, the trigger symbols may adopt the ability to be substitutable for other symbols in the reel-based game, other than Scatter symbols. Note that because the bonus outcome event is the first bonus outcome event, all of the trigger symbols are new trigger symbols that were not previously locked-down.

Next, block 1122 includes sending, by the server machine 100a, data for displaying, by the display 110b of the client machine 100b, a signal that the trigger symbols are adopting the functionality of Wild symbols for purposes of determining the payout amount.

Next, block 1124 includes sending, by the server machine 100a, data for displaying, by the display 110b of the client machine 100b, the determined payout amount.

Turning to FIG. 11C, block 1126 includes making, by the server machine 100b, a determination that one or more of the awarded bonus outcome events remain to be played.

Next, block 1128 includes making, by the server machine 100b, a determination that the first bonus symbol set includes less than n trigger symbols.

Next, block 1130 includes, responsive to determining that the first bonus symbol set includes less than n trigger symbols, locking down, by the server machine 100b, all instances of the trigger symbol in the first bonus symbol set.

Next, block 1132 includes, selecting, by the server machine 100b, a second bonus symbol set for the remaining bonus outcome event. The second bonus symbol set contains a symbol for each symbol position in the symbol-display-portion of the display 110b of the client machine 100b that does not already include an instance of the trigger symbol.

Turning to FIG. 11D, block 1134 includes making, by the server machine 100a, a determination that a third trigger event occurred during the remaining bonus outcome event. For example, occurrence of the trigger event can include the presence of at least one new trigger symbol in the second bonus symbol set.

Next, block 1136 includes, responsive to determining that the first trigger event occurred, determining, by the server machine 100a using the stored payout table, a payout amount associated with the second bonus symbol set. For purposes of determining the payout amount, one or more trigger symbols in the second bonus symbol set may adopt the functionality of Wild symbols and temporarily become substitutable for other symbols in the reel-based game, other than Scatter symbols. In one example, the question of which trigger symbols adopt the functionality of Wild symbols may depend on the total number of trigger symbols in the second bonus symbol set in relation to a predetermined number of trigger symbols, n. If the total number of trigger symbols is less than n, all of the trigger symbols may adopt the functionality of Wild symbols. Whereas, if the total number of trigger symbols is greater than or equal to n, the new trigger symbols in the second bonus symbol set may adopt the functionality of Wild symbols, but the old trigger symbols (locked-down from the first bonus symbol set) do not adopt the functionality of Wild symbols.

Alternatively, in another example, all trigger symbols in the second bonus symbol set may adopt the functionality of Wild symbols for purposes of determining the payout amount regardless of the total number of trigger symbols in the second bonus symbol set.

Next, block 1138 includes sending, by the server machine 100a, data for displaying, by the display 110b of the client machine 100b, for the trigger symbols adopting the functionality of Wild symbols, respective signals that the trigger symbols are adopting the functionality of Wild symbols for purposes of determining the payout amount.

Next, block 1140 includes sending, by the server machine 100a, data for displaying, by the display 110b of the client machine 100b, the determined payout amount.

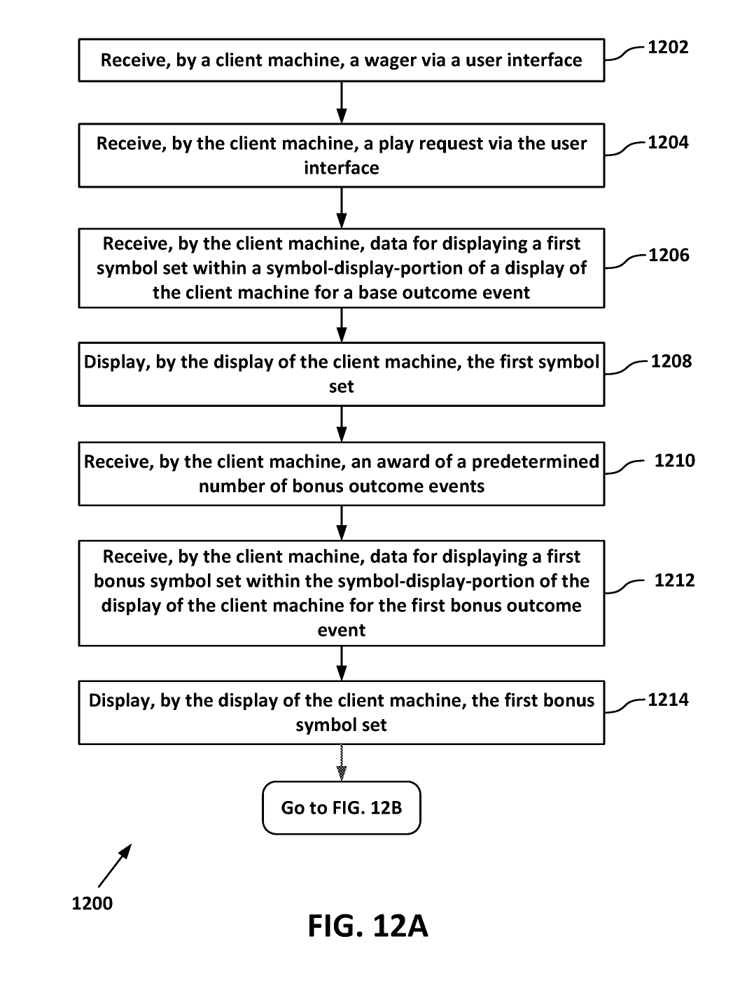

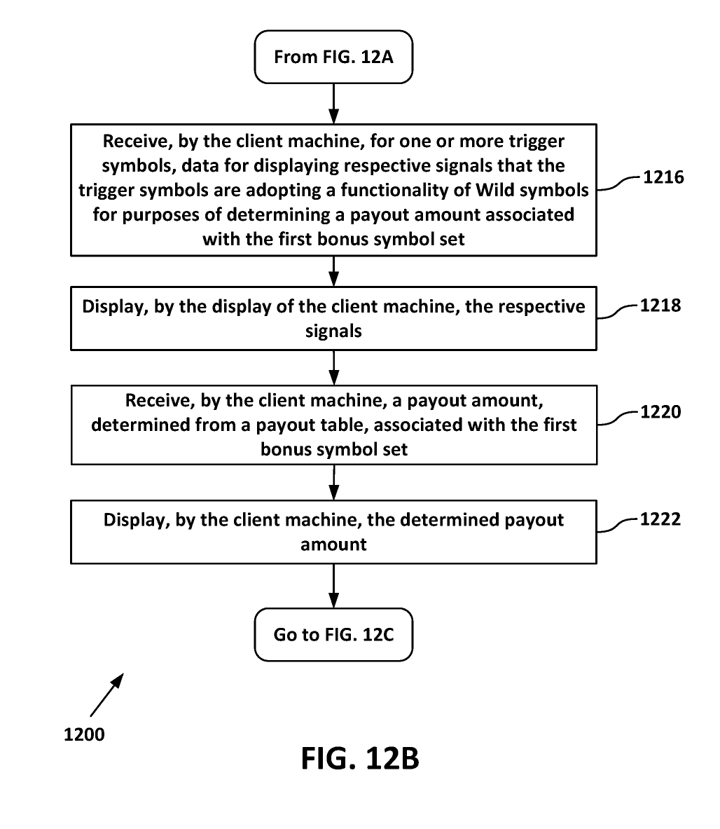

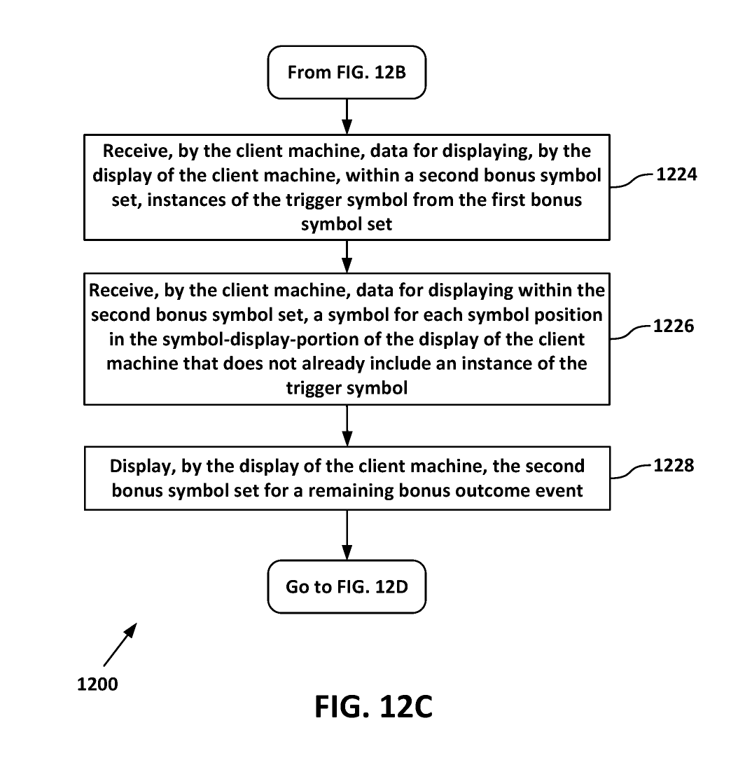

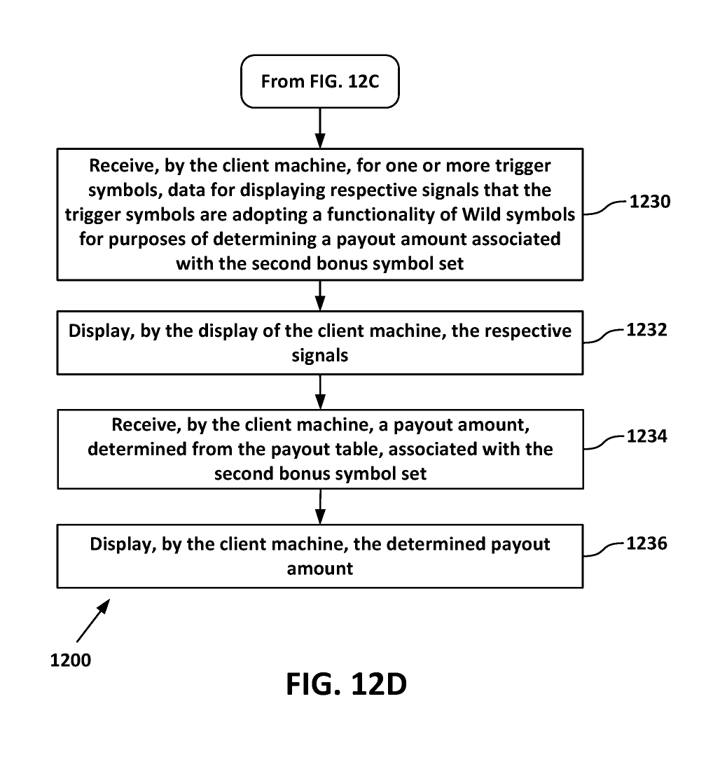

FIGS. 12A-12D depict a flowchart showing a set of operations 1200 (or more simply, “the set 1200”) that can, for example, be carried out using client machine 100b. Note that several of the operations described in connection with FIGS. 12A-12D parallel operations described in connection with FIGS. 6A-6D and FIGS. 11A-11D. As such, variations of the operations described in connection with FIGS. 6A-6D and FIGS. 11A-11D are likewise applicable to the operations described in connection with FIGS. 12A-12D. However, for the sake of brevity, these variations are not repeated. The client machine 100b, in performing the set 1200, can perform the operations described above with respect to machine 100.

Turning to FIG. 12A, block 1202 includes receiving, by the client machine 100b, a wager via the user interface 104b. Client machine 100b can transmit the received wager or data indicative thereof over the communication network 116 to server machine 100a.

Next, block 1204 includes receiving, by the client machine 100b, a play request via the user interface 104b. Client machine 100b can transmit the received play request or data indicative thereof over the communication network 116 to server machine 100a.

Next, block 1206 includes receiving, by the client machine 100b, data for displaying a first symbol set within the symbol-display-portion of the display 110b for a base outcome event.

Next, block 1208 includes displaying, by the display 100b of the client machine 100b, the first symbol set.

Next, block 1210 includes receiving, by the client machine 100b, an award of a predetermined number of bonus outcome events.

Next, block 1212 includes, receiving, by the client machine 100b, data for displaying a first bonus symbol set within the symbol-display-portion of the display 110b of the client machine 100b for the first bonus outcome event.

Next, block 1214 includes, displaying, by the client machine 100b, the first bonus symbol set.

Turning to FIG. 12B, block 1216 includes receiving, by the client machine 100b, for one or more trigger symbols, data for displaying respective signals that the trigger symbols are adopting the functionality of Wild symbols for purposes of determining a payout amount associated with the first bonus symbol set.

Next, block 1218 includes displaying, by the display 110b of the client machine 100b, the respective signals.

Next, block 1220 includes receiving, by the client machine 100b, a payout amount associated with the first bonus symbol set.

Next, block 1222 includes displaying, by the client machine 100b, the determined payout amount.

Turning to FIG. 12C, optionally, block 1224 includes receiving, by the client machine 100b, data for displaying, by the display 110b of the client machine 100b, within a second bonus symbol set, instances of the trigger symbol from the first bonus symbol set.

Next, block 1226 includes receiving, by the client machine 100b, additional data for displaying within the second bonus symbol set. The additional data includes a symbol for each position in the symbol-display-portion of the display 110b of the client machine 100b that does not already include an instance of the trigger symbol.

Next, block 1228 includes displaying, by the client machine 100b, the second bonus symbol set for a remaining bonus outcome event.

Turning to FIG. 12D, block 1230 receiving, by the client machine 100b, for one or more trigger symbols, data for displaying respective signals that the trigger symbols are adopting the functionality of Wild symbols for purposes of determining a payout amount associated with the second bonus symbol set.

Next, block 1232 includes displaying, by the display 110b of the client machine 100b, the respective signals.

Next, block 1234 includes receiving, by the client machine 100b, a payout amount associated with the first bonus symbol set.

Next, block 1236 includes displaying, by the client machine 100b, the determined payout amount.

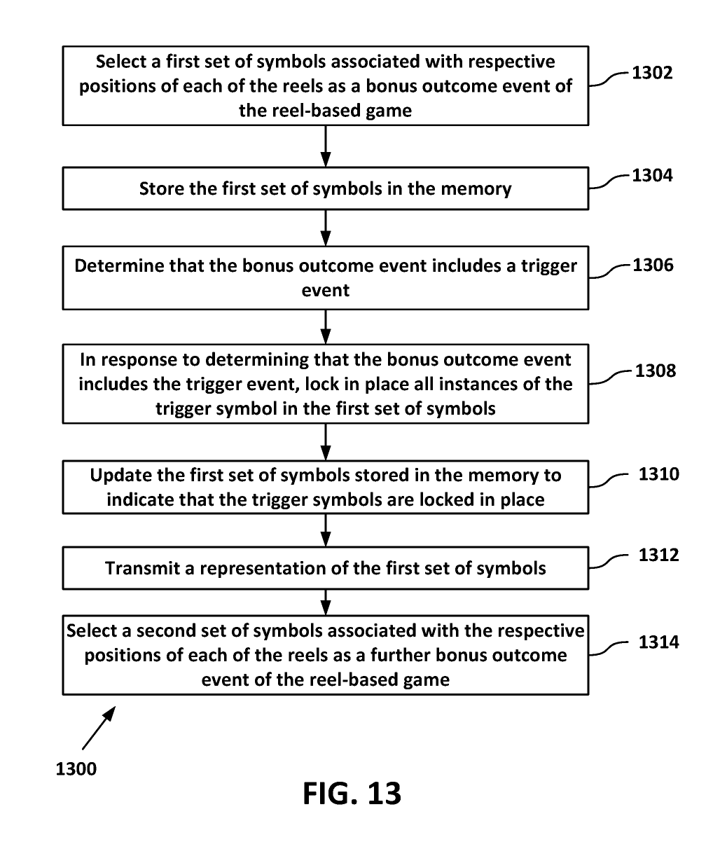

FIG. 13 depicts a flowchart showing a set of operations 1300 (or more simply, “the set 1100”) that can, for example, be carried out using server machine 100a and/or client machine 100b. To the extent that a client machine carries out any of the set 1300, these operations may also include displaying various types of information, such as symbol sets, payout amounts, and so on. Note that several of the operations described in connection with FIG. 13 parallel operations described in connection with FIGS. 6A-6D, FIGS. 11A-11D, and FIGS. 12A-12D. As such, variations of the operations described in connection with FIGS. 6A-6D, FIGS. 11A-11D, and FIGS. 12A-12D are likewise applicable to the operations described in connection with FIG. 13.

Turning to FIG. 13, block 1302 includes selecting a first set of symbols associated with respective positions of each of the reels as a bonus outcome event of the reel-based game. The bonus outcome event may have been caused by a trigger event in a base game of the reel-based game

Next, block 1304 includes storing the first set of symbols in the memory.

Next, block 1306 includes determining that the bonus outcome event includes a trigger event. The trigger event may involve at least one but less than n trigger symbols appearing in the first set of symbols (e.g., at least one but less than n trigger symbols appearing anywhere in the first symbol set, appearing on a designated reel, or appearing in a designated row and/or column of the display).

Next, block 1308 includes in response to determining that the bonus outcome event includes the trigger event, locking in place all instances of the trigger symbol in the first set of symbols. The locked trigger symbols may persist for at least one further bonus outcome event.

Next, block 1310 includes updating the first set of symbols stored in the memory to indicate that the trigger symbols are locked in place.

Next, block 1312 includes transmitting a representation of the first set of symbols. Reception of the representation of the first set of symbols may cause the client machine to display the first set of symbols on a screen.

Next, block 1314 selecting a second set of symbols associated with the respective positions of each of the reels as a further bonus outcome event of the reel-based game The second set of symbols may include the locked in place trigger symbols from the first set of symbols.

In some embodiments, the respective pluralities of symbols for the reels may be arranged in respective cyclical sequences of symbols. Selecting the set of symbols may involve, for each reel, randomly selecting a respective reel position such that a respective subsequence of the symbols thereon are in the set of symbols. Selecting the set of symbols may involve simulating spins of the plurality of reels. The reel-based game may have five reels and each of the five reels may contribute three symbols to the set of symbols. Other arrangements are possible.

In some embodiments, the trigger event may involve the set of symbols including at least one but less than n trigger symbols. The value of n may be 2, 3, 4, and so on.

In some embodiments, the trigger symbols may be Scatter symbols. The Scatter symbols may be symbols that trigger an award of at least one additional bonus outcome event when at least n of the symbols appear in a set of symbols. The Scatter symbols need not appear on a pay line in order for the additional bonus outcome event to be awarded.

In some embodiments, reception of the representation of the second set of symbols may cause the client machine to display, on the screen, a spin of the plurality of reels resulting in the second set of symbols. Further, during the spin, the locked trigger symbols may be locked in place on the screen.

In some embodiments, the bonus game may include a predetermined number of bonus outcome events. Further, it may be determined that the second set of symbols includes at least n trigger symbols. In response to determining that the second set of symbols includes at least n trigger symbols, at least one additional bonus outcome event may be awarded and an indication of the award of the additional bonus outcome event may be transmitted. Additionally, in response to determining that the second set of symbols includes at least n trigger symbols, all locked in place trigger symbols in the second set of symbols may be unlocked and the second set of symbols in the memory may be updated to indicate that the trigger symbols are no longer locked in place.

In some embodiments, prior to selecting the second set of symbols and in response to determining that the first set of symbols includes at least one trigger symbol, a bonus payout amount associated with the first set of symbols may be determined. For purposes of determining the payout amount, the trigger symbols may adopt a functionality of Wild symbols. For instance, the trigger symbols may become substitutable for other symbols in the reel-based game for purposes of determining the payout amount.

Further, the representation of the first set of symbols may include an indication that the trigger symbols are adopting the functionality of Wild symbols. Reception of the representation of the first set of symbols may cause the client machine to display a signal that the trigger symbols are adopting the functionality of Wild symbols.

In some embodiments, in response to determining that the second set of symbols includes a new trigger symbol and greater than or equal to n total trigger symbols, a bonus payout amount associated with the second set of symbols may be determined. For purposes of determining the payout amount, the new trigger symbol may adopt a functionality of a Wild symbol. For instance, the new trigger symbol may temporarily become substitutable for other symbols in the reel-based game for purposes of determining the payout amount. However, the locked trigger symbols might not adopt the functionality of Wild symbols.

In some embodiments, in response to determining that the second set of symbols includes at least one trigger symbol, a bonus payout amount associated with the second set of symbols may be determined. For purposes of determining the payout amount, the trigger symbols may adopt a functionality of Wild symbols. For instance, the trigger symbols that may temporarily become substitutable for other symbols in the reel-based game for purposes of determining the bonus payout amount.

In examples where trigger symbols of the second set of symbols adopt the functionality of Wild symbols, a representation of the second set of symbols may be transmitted to the client machine. The representation of the second set of symbols may include, for trigger symbols adopting the functionality of Wild symbols, respective indications that the trigger symbols are adopting the functionality of Wild symbols for purposes of determining the bonus payout amount. Reception of the representation of the second set of symbols may cause the client machine to display, for the trigger symbols adopting the functionality of Wild symbols, respective signals that the trigger symbols are adopting the functionality of Wild symbols.

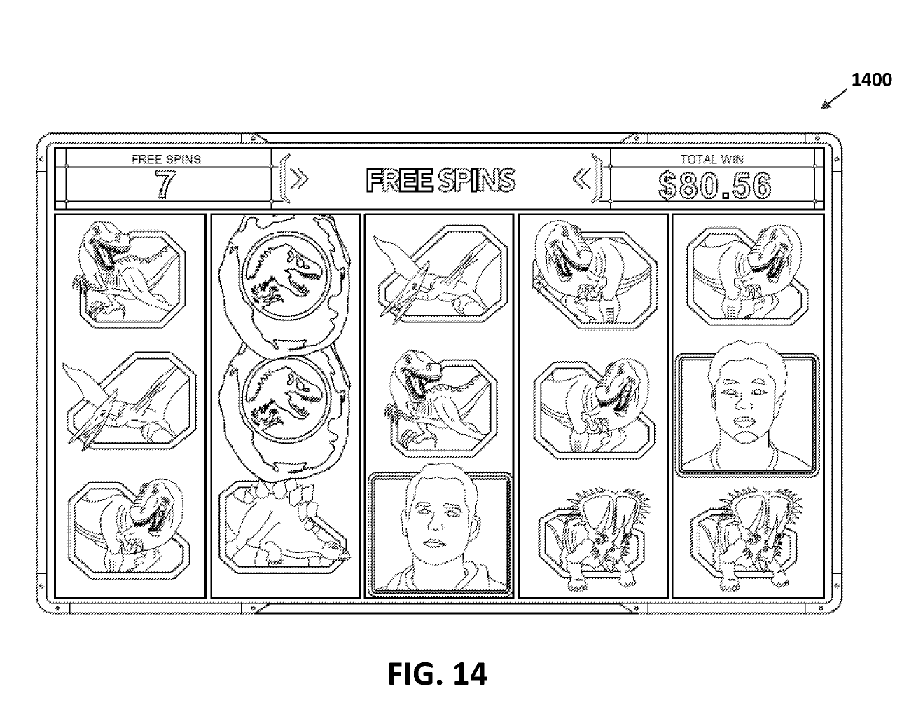

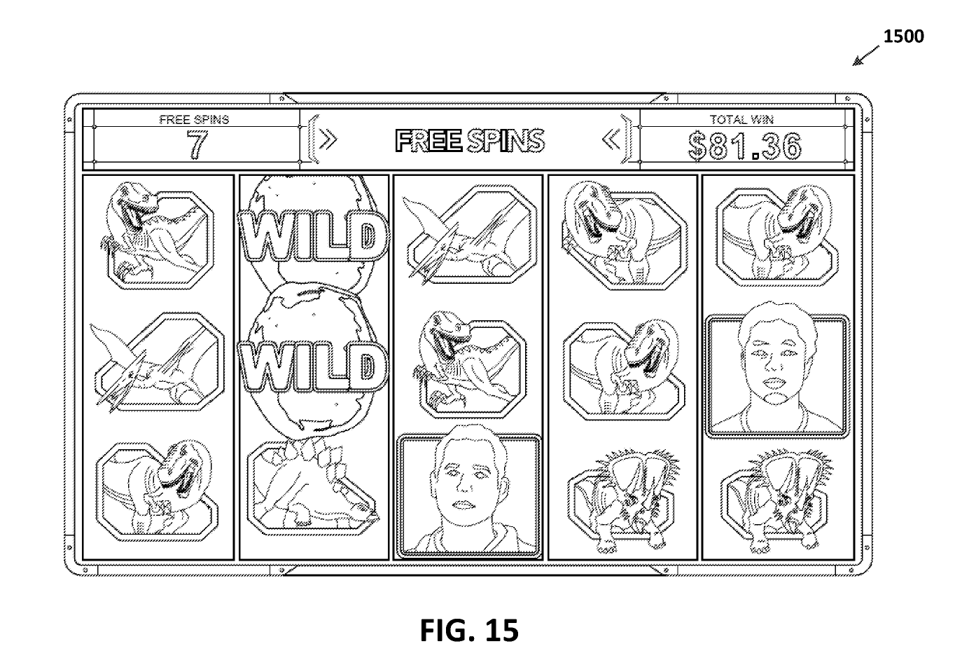

FIGS. 14, 15, 16, 17, 18, and 19 provide examples of animations that may occur in a reel-based bonus game. In FIG. 14, display 1400 depicts trigger symbols appearing at arrangement positions C2,R1 and C2,R2 on a five-column, three-row matrix of symbols. In FIG. 15, display 1500 depicts the trigger symbols at arrangement positions C2,R1 and C2,R2 as adopting the functionality of Wild symbols for purposes of determining any payout amount.

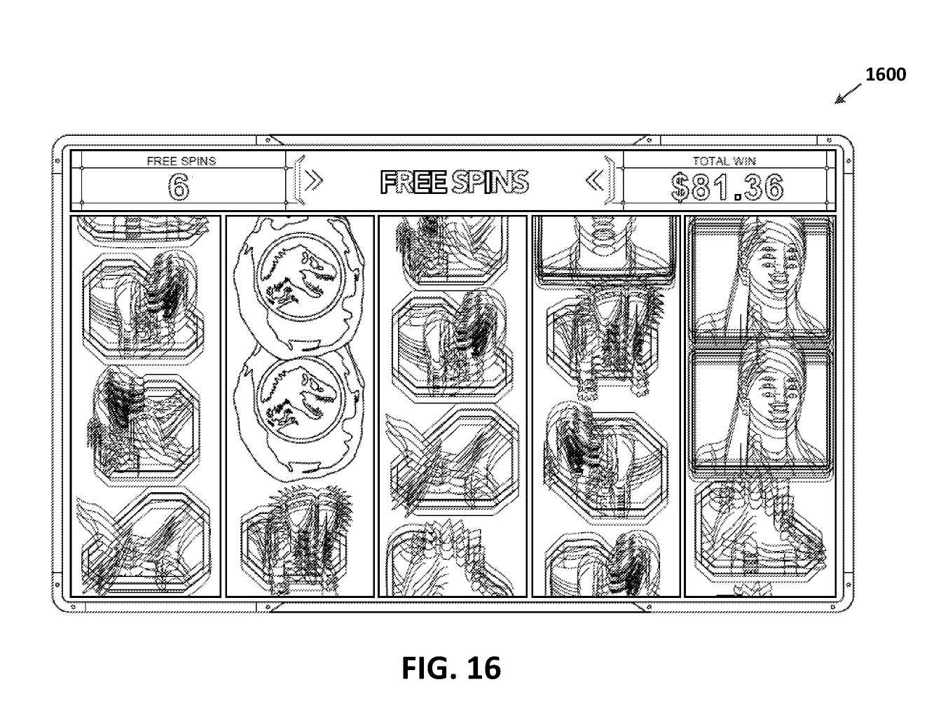

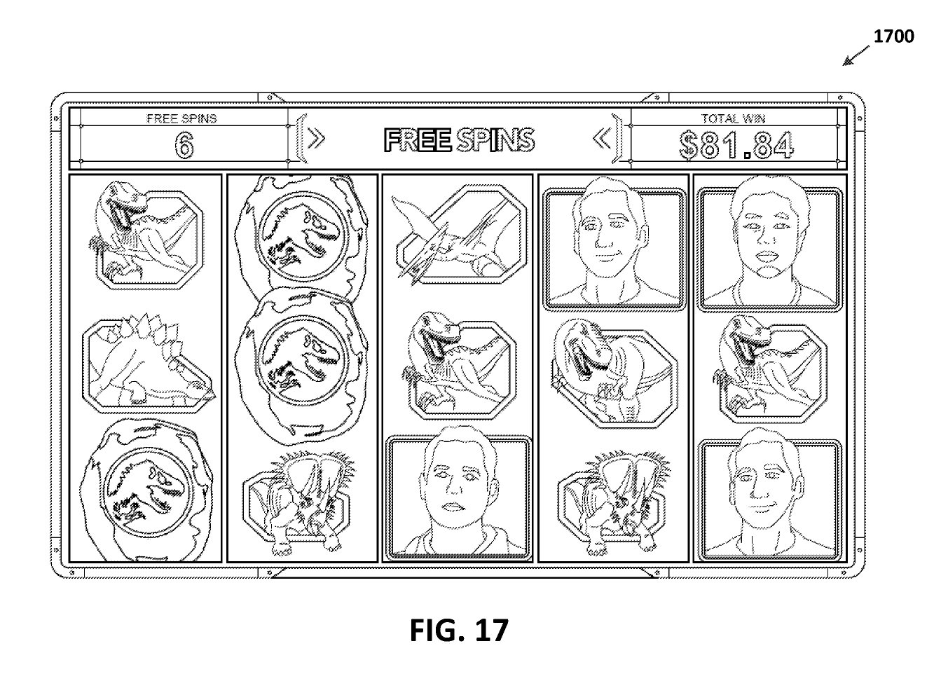

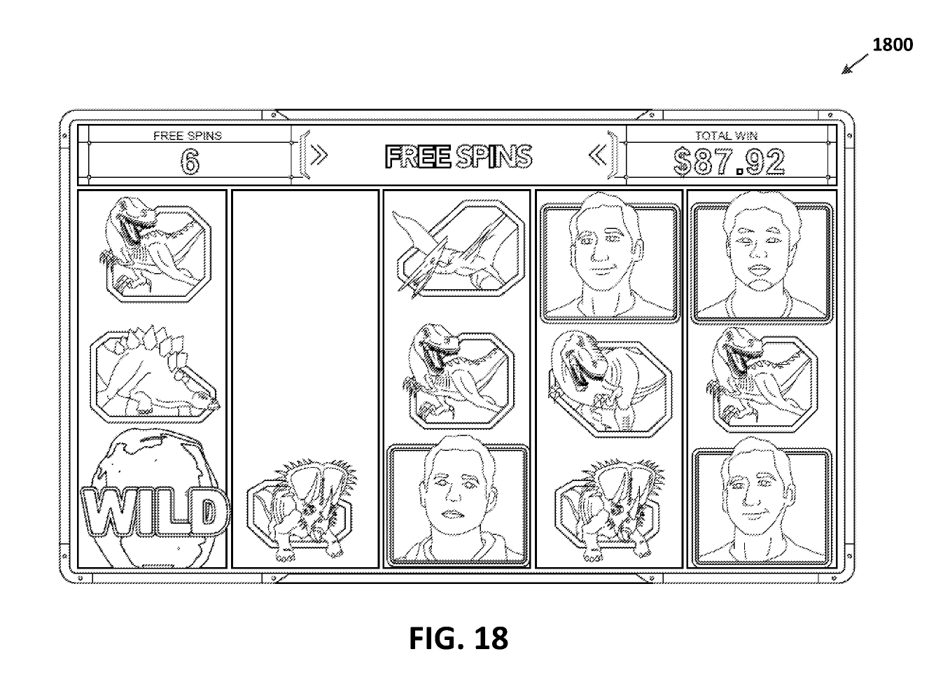

In FIG. 16, display 1600 depicts the trigger symbols at arrangement positions C2,R1 and C2,R2 locked in place as the reels spin. In FIG. 17, display 1700 depicts the locked in place trigger symbols as well as a newly appearing trigger symbol at arrangement position C1,R3. In FIG. 18, display 1800 depicts the newly appearing trigger symbol at arrangement position C1,R3 as adopting the functionality of a Wild symbol for purposes of determining any payout amount. Display 1800 also depicts the locked in place trigger symbols previously shown at arrangement positions C2,R1 and C2,R2 in FIG. 17 as released (i.e. no longer appearing). In some cases, the locked in place trigger symbols at arrangement positions C2,R1 and C2,R2 may also be replaced with Wild symbols (not shown) for purposes of determining any payout amount.

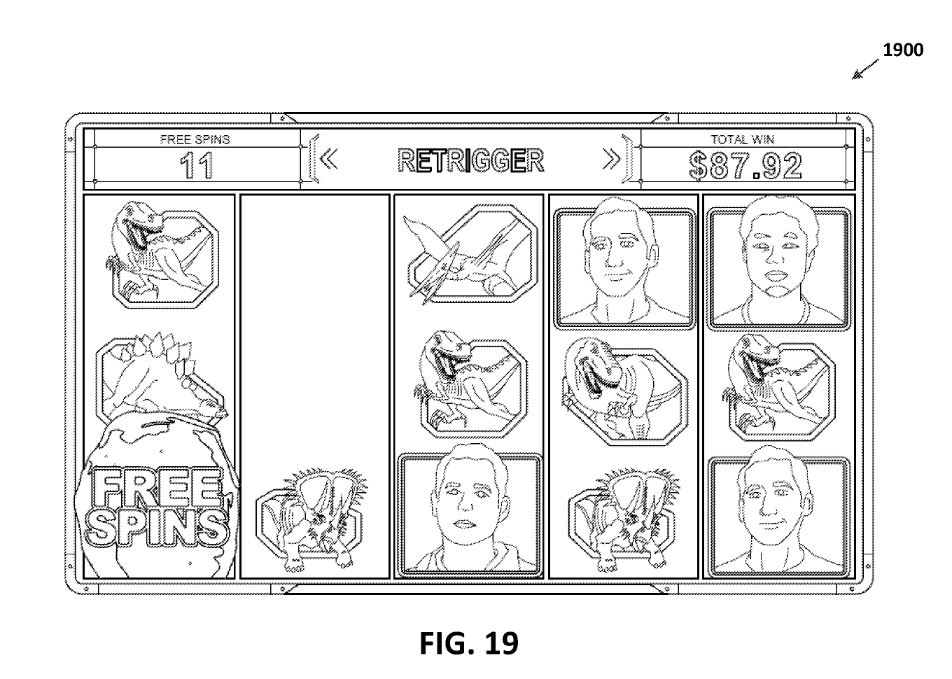

In FIG. 19, display 1900 depicts an award of additional bonus outcome events (i.e. free spins). The award of additional free spins is triggered by the presence of three trigger symbols (see FIG. 17). Because at least three trigger symbols appeared, the additional free spins are awarded and the locked trigger symbols at arrangement positions C2,R1 and C2,R2 are unlocked for future bonus outcome events. Further, because at least three trigger symbols appeared, the trigger symbol at arrangement position C1,R3 remains unlocked for future bonus outcome events.

Some embodiments may involve simultaneously executing reel-based games in real time on behalf of at least 30 client machines, where each of the at least 30 client machines communicates with the one or more processors by way of a wide-area, packet-switched network. In some cases, the one or more processors may simultaneously execute reel-based games in real time on behalf of more or fewer than 30 client machines. For instance, this simultaneous execution may involve 10, 20, 50, 100, or 1000 client machines, or another extent of client machines.

Particularly, simultaneous execution of such a large number of reel-based games in real time necessitates computer implementation. When taking part in an online game, such as the reel-based games disclosed herein, players expect results of reel spin or symbol replacement operations to be displayed on their respective client machines in an expeditious fashion (e.g., in real time, such as a few seconds at most per either of these operations). Failure to do so may result in players becoming disinterested in the game. Consequently, the embodiments that include this simultaneous execution a large number of reel-based games in real time would not exist but for computer implementation thereof.

### V. Conclusion

While one or more disclosed operations have been described as being performed by certain entities (e.g., machine 100, server machine 100a, or client machine 100b), one or more of the operations may be performed by any entity, including but not limited to those described herein. As such, while this disclosure includes examples in which the server machine 100a performs select operations and sends data to the client machine 100b, such that the client machine 100b may perform complementing operations and receive the data, variations may to those operations may be made while adhering to the general server-client dichotomy and the scope of the disclosed machines and methods.

For example, rather than the server machine 100a sending select data (e.g., a symbol set) to the client machine 100b, such that the client machine may generate and display appropriate images, the server machine 100a may itself generate the images and send them to the client machine 100b for display. Indeed, it will be appreciated by one of ordinary skill in the art that the “break point” between the server machine's operations and the client machine's operations may be varied.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

What is claimed is:

1. A computer-implemented method involving a software application executed by a server machine on behalf of a client machine with a graphical display unit, wherein the software application involves graphically displaying, on vertical symbol display segments of the graphical display unit, animations that simulate spinning a plurality of reels, and wherein a memory of the server machine stores, for each reel of the plurality of reels, a respective plurality of symbols, subsets of which are displayable in a respective vertical symbol display segment corresponding to the reel, the computer-implemented method comprising:
selecting, by a processor of the server machine executing the software application, a first set of symbols associated with respective positions of each of the reels as an outcome event of the software application;
causing, by the processor, the graphical display unit to display a first animation that simulates a first spin of the reels that results in the vertical symbol display segments displaying the first set of symbols;
determining, by the processor, that the first set of symbols includes exactly one or exactly two trigger symbols;
in response to determining that the first set of symbols includes exactly one or exactly two trigger symbols, locking in place, by the processor, all instances of the trigger symbols in the first set of symbols, wherein the locked-in-place trigger symbols persist for at least one further outcome event;
selecting, by the processor, a second set of symbols associated with the respective positions of each of the reels as a further outcome event of the software application, wherein the second set of symbols includes the locked-in-place trigger symbols from the first set of symbols;
causing, by the processor, the graphical display unit to display a second animation that simulates a second spin of the reels that results in the vertical symbol display segments displaying the second set of symbols, wherein the locked-in-place trigger symbols are not spun in the second spin of the reels;
determining, by the processor, that the second set of symbols includes at least three trigger symbols; and
in response to determining that the second set of symbols includes at least three trigger symbols: the processor (i) providing at least one additional spin of the reels to the client machine, and (ii) unlocking all locked-in-place in place trigger symbols in the second set of symbols.

2. The computer-implemented method of claim 1, wherein each reel comprises a respective cyclical sequence of symbols, and wherein selecting the first set of symbols associated with respective positions of each of the reels comprises:
for each reel, randomly selecting a respective reel position that displays, on the associated vertical symbol display segment, a subsequence of the symbols on the reel that are part of the first set of symbols.

3. The computer-implemented method of claim 1, wherein the software application includes five reels and each of the five reels contributes three symbols to the first set of symbols and the second set of symbols.

4. The computer-implemented method of claim 1, wherein the processor simultaneously executes the software application in real-time on behalf of at least 30 client machines, and wherein each of the at least 30 client machines communicates with the server machine by way of a wide-area packet-switched network.

5. The computer-implemented method of claim 1, wherein the second animation comprises an indication that the trigger symbols that were not locked in place are adopting the functionality of wild symbols, wherein the functionality comprises being substitutable for other symbols.

6. The computer-implemented method of claim 5, further comprising:
in response to determining that the second set of symbols includes at least three trigger symbols, determining a bonus payout amount associated with the second set of symbols, wherein the bonus payout amount is based on the wild symbols being substitutable for other symbols, and wherein the locked-in-place trigger symbols do not adopt the functionality of wild symbols for purposes of determining the bonus payout amount.

7. The computer-implemented method of claim 1, wherein causing the graphical display unit to display the first animation comprises transmitting a first representation of the first set of symbols to the client machine, wherein reception of the representation of the first set of symbols causes the client machine to display the first animation, wherein causing the graphical display unit to display the second animation comprises transmitting a second representation of the second set of symbols to the client machine, and wherein reception of the representation of the second set of symbols causes the client machine to display the second animation.

8. The computer-implemented method of claim 1, wherein the client machine is associated with a credit account, and wherein the credit account is debited to select the first set of symbols and credited based on patterns in the second set of symbols.

9. A non-transitory computer-readable medium having stored thereon program instructions that define a software application, wherein the software application is executed by a server machine on behalf of a client machine with a graphical display unit, wherein the software application involves graphically displaying, on vertical symbol display segments of the graphical display unit, animations that simulate spinning a plurality of reels, wherein a memory of the server machine stores, for each reel of the plurality of reels, a respective plurality of symbols, subsets of which are displayable in a respective vertical symbol display segment corresponding to the reel, and wherein, upon execution by the server machine, the program instructions cause the server machine to perform operations comprising:
selecting a first set of symbols associated with respective positions of each of the reels as an outcome event of the software application;
causing the graphical display unit to display a first animation that simulates a first spin of the reels that results in the vertical symbol display segments displaying the first set of symbols;
determining that the first set of symbols includes exactly one or exactly two trigger symbols;
in response to determining that the first set of symbols includes exactly one or exactly two trigger symbols, locking in place all instances of the trigger symbols in the first set of symbols, wherein the locked-in-place trigger symbols persist for at least one further outcome event;
selecting a second set of symbols associated with the respective positions of each of the reels as a further outcome event of the software application, wherein the second set of symbols includes the locked-in-place trigger symbols from the first set of symbols;
causing the graphical display unit to display a second animation that simulates a second spin of the reels that results in the vertical symbol display segments displaying the second set of symbols, wherein the locked-in-place trigger symbols are not spun in the second spin of the reels;
determining that the second set of symbols includes at least three trigger symbols; and
in response to determining that the second set of symbols includes at least three trigger symbols: (i) providing at least one additional spin of the reels to the client machine, and (ii) unlocking all locked-in-place in place trigger symbols in the second set of symbols.

10. The non-transitory computer-readable medium of claim 9, wherein each reel comprises a respective cyclical sequence of symbols, and wherein selecting the first set of symbols associated with respective positions of each of the reels comprises:
for each reel, randomly selecting a respective reel position that displays, on the associated vertical symbol display segment, a subsequence of the symbols on the reel that are part of the first set of symbols.

11. The non-transitory computer-readable medium of claim 9, wherein the software application includes five reels and each of the five reels contributes three symbols to the first set of symbols and the second set of symbols.

12. The non-transitory computer-readable medium of claim 9, wherein the processor simultaneously executes the software application in real-time on behalf of at least 30 client machines, and wherein each of the at least 30 client machines communicates with the server machine by way of a wide-area packet-switched network.

13. The non-transitory computer-readable medium of claim 9, wherein the second animation comprises an indication that the trigger symbols that were not locked in place are adopting the functionality of wild symbols, wherein the functionality comprises being substitutable for other symbols.

14. The non-transitory computer-readable medium of claim 13, the operations further comprising:
in response to determining that the second set of symbols includes at least three trigger symbols, determining a bonus payout amount associated with the second set of symbols, wherein the trigger symbols that were not locked in place adopt a functionality of wild symbol for purposes of determining the bonus payout amount, wherein the functionality comprises being substitutable for other symbols, and wherein the locked-in-place trigger symbols do not adopt the functionality of wild symbols for purposes of determining the bonus payout amount.

15. The non-transitory computer-readable medium of claim 9, wherein causing the graphical display unit to display the first animation comprises transmitting a first representation of the first set of symbols to the client machine, wherein reception of the representation of the first set of symbols causes the client machine to display the first animation, wherein causing the graphical display unit to display the second animation comprises transmitting a second representation of the second set of symbols to the client machine, and wherein reception of the representation of the second set of symbols causes the client machine to display the second animation.

16. The non-transitory computer-readable medium of claim 9, wherein the client machine is associated with a credit account, and wherein the credit account is debited to select the first set of symbols and credited based on patterns in the second set of symbols.

17. A system configured for executing a software application, wherein the software application involves graphically displaying, on vertical symbol display segments, animations that simulate spinning a plurality of reels, and wherein the system stores, for each reel of the plurality of reels, a respective plurality of symbols, subsets of which are displayable in a respective vertical symbol display segment corresponding to the reel, the system comprising:
a client machine including a client machine processor, a client machine memory, a graphical display unit, and a plurality of input devices, wherein the plurality of input devices include: (i) an acceptor of a physical item associated with a monetary value, (ii) a validator configured to identify the physical item, and (iii) a cash-out button actuatable to cause an initiation of a payout associated with a credit account; and
program instructions executable to perform operations comprising:
selecting a first set of symbols associated with respective positions of each of the reels as an outcome event of the software application;
causing the graphical display unit to display a first animation that simulates a first spin of the reels that results in the vertical symbol display segments displaying the first set of symbols;
determining that the first set of symbols includes exactly one or exactly two trigger symbols;
in response to determining that the first set of symbols includes exactly one or exactly two trigger symbols, locking in place all instances of the trigger symbols in the first set of symbols, wherein the locked-in-place trigger symbols persist for at least one further outcome event;
selecting a second set of symbols associated with the respective positions of each of the reels as a further outcome event of the software application, wherein the second set of symbols includes the locked-in-place trigger symbols from the first set of symbols;
causing the graphical display unit to display a second animation that simulates a second spin of the reels that results in the vertical symbol display segments displaying the second set of symbols, wherein the locked-in-place trigger symbols are not spun in the second spin of the reels;
determining that the second set of symbols includes at least three trigger symbols; and
in response to determining that the second set of symbols includes at least three trigger symbols: (i) providing at least one additional spin of the reels to the client machine, and (ii) unlocking all locked-in-place in place trigger symbols in the second set of symbols.

18. The system of claim 17, wherein the second animation comprises an indication that the trigger symbols that were not locked in place are adopting the functionality of wild symbols, wherein the functionality comprises being substitutable for other symbols.

19. The system of claim 18, the operations further comprising:
in response to determining that the second set of symbols includes at least three trigger symbols, determining a bonus payout amount associated with the second set of symbols, wherein the bonus payout amount is based on the wild symbols being substitutable for other symbols, and wherein the locked-in-place trigger symbols do not adopt the functionality of wild symbols for purposes of determining the bonus payout amount.

20. The system of claim 17, wherein causing the graphical display unit to display the first animation comprises transmitting a first representation of the first set of symbols to the client machine, wherein reception of the representation of the first set of symbols causes the client machine to display the first animation, wherein causing the graphical display unit to display the second animation comprises transmitting a second representation of the second set of symbols to the client machine, and wherein reception of the representation of the second set of symbols causes the client machine to display the second animation.
